(19) United States
(12) Patent Application Publication
(10) Pub. No.: US 2008/0193165 A1
(43) Pub. Date: Aug. 14, 2008

(54) IMAGE FORMING APPARATUS

(76) Inventors: Shinji Nakazawa, Soraku-gun (JP); Yoshiharu Yoneda, Nara-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/028,089

(22) Filed: Feb. 8, 2008

(30) Foreign Application Priority Data
Feb. 14, 2007 (JP) 2007-033644
Feb. 14, 2007 (JP) 2007-033645
Mar. 14, 2007 (JP) 2007-065219

(51) Int. Cl. G03G 15/00

(52) U.S. Cl. 399/167

(57) ABSTRACT

An image forming apparatus includes a photoreceptor drum, a developing roller, a registration roller for positioning and conveying the paper and a drive controller for controlling the drive of the registration roller. The registration roller conveys the paper so that its leading end collides with the photoreceptor drum. The drive controller corrects the timing of driving the registration roller based on the detected eccentric variation of the peripheral surface of the photoreceptor drum and the rotational phase. The drive controller may acquire the eccentric variation as external data instead of detecting it.

This Nonprovisional application claims priority under 35 U.S.C. §119 (a) on Patent Application No. 2007-33644 filed in Japan on 14 Feb. 2007, Patent Application No. 2007-33645 filed in Japan on 14 Feb. 2007 and Patent Application No. 2007-65219 filed in Japan on 14 Mar. 2007, the entire contents of which are hereby incorporated by reference.

### BACKGROUND OF THE INVENTION

(1) Field of the Invention

The present invention relates to an image forming apparatus, and in particular relates to an image forming apparatus that performs image printing by visualizing a toner image from an electrostatic latent image formed on a photoreceptor drum and transferring the toner image to a recording medium being conveyed.

(2) Description of the Prior Art

Conventionally, in the image forming apparatus such a printer or the like using electrophotography, images are printed out by the steps of electrifying a rotationally driven photoreceptor drum with a charger, forming an electrostatic latent image on the photoreceptor drum by illuminating the drum with light in accordance with image information, forming a toner image by adhering toner to this electrostatic latent image by means of a developing device and transferring the toner image to a recording medium such as sheet material, paper or the like.

When the toner image on the photoreceptor drum is transferred to the paper, a registration roller that is arranged along the paper feed path on the upstream side of the photoreceptor with respect to the paper feed direction, for example is used to adjust the timing of paper feed so as to make the toner image on the photoreceptor drum in register with the paper.

In recent years, image forming apparatuses tend to adopt so-called borderless printing, which allows for printing across the whole area of paper. This process requires the apparatus to transfer the image to the paper with highly positional accuracy.

However, with the conventional image forming apparatuses there have been the problem that if the shape or axis of the photoreceptor drum is off-centered, the paper's leading end that abuts the photoreceptor drum slightly becomes out of position, causing positional deviation of the image to be transferred to the paper in a case of borderless printing or causing misregistration of superposed images in a case of color printing where a plurality of toner images are layered to complete a full color image.

To deal with this, as a prior art example of an image forming apparatus there is a configuration which includes measuring devices for measuring the conditions of eccentricity of the photoreceptor drums on which images are formed and a controlling device for controlling the transfer timings of individual color images based on the detected conditions of eccentricity and in which the photoreceptor drum of each color is stopped at the position where the eccentric variation of the photoreceptor drum is maximum and then the drum is controlled to be driven so that the leading end of the paper is made in register to thereby improve transfer positional accuracy (patent document 1: Japanese Patent Application Laid-open Hei 6-250474).

As another example of the prior art, there is a proposal of an image forming apparatus which includes: a writing means for writing image data, line by line, in the main scan direction on the peripheral surface of the photoreceptor drum along the axial direction thereof; a variation detecting means for detecting the variation of the peripheral surface resulting from the eccentricity of the rotational axis of the photoreceptor drum; and a correction control means for correcting and controlling the interval between main scan lines on the photoreceptor drum's peripheral surface in accordance with the variation of the photoreceptor drum, and is configured so that, the timing of writing the image data is corrected by writing the main scan lines an detecting the eccentric variation of the photoreceptor drum's peripheral surface based on the variation of the interval between main scan lines with respect to the sub scan direction to thereby improve transfer positional accuracy (see patent document 2; Japanese Patent Application Laid-open Hei 10-246995).

As another countermeasure for solving the deviation problem of transfer timing, there is a proposal in which the length of the paper feed path between the image transfer position and the position of paper detection is set equal to an integer multiple of the circumference of the registration roller so as to eliminate the deviation of paper feed timing as a result of the eccentricity of the registration roller (patent document 3: Japanese Patent Application Laid-open Hei 11-174757).

As to the above prior art, in the mechanism of patent document 1, the operation of the drive for each component needs to be controlled so as to make the leading end of paper in register based on the detected eccentricity of each photoreceptor drum, hence the operational control of each component becomes complicated.

The mechanism of patent document 2 needs such a complicated control that the timing of writing image data is corrected in accordance with the variation of the interval between main scan lines.

Further, the mechanism of patent document 3 makes it possible to eliminate the influence by the eccentricity of the registration roller but entails the problem that the transfer position varies due to the eccentricity of the photoreceptor drum.

### SUMMARY OF THE INVENTION

The present invention has been devised in view of the above conventional problems, it is therefore an object of the present invention to provide an image forming apparatus which makes it possible with a simple structure to make the leading end of paper register with the toner image on the photoreceptor drum without being affected by the rotational phase of the photoreceptor drum and improve the accuracy of the transfer position of the image by eliminating the deviation of transfer timing due to the eccentricity of the photoreceptor drum.

The configuration of the image forming apparatus according to the present invention for solving the above problem is as follows.

According to the first aspect of the present invention, an image forming apparatus that is controlled so as to transfer a toner image formed on the peripheral surface of a photoreceptor drum to a recording medium by electrophotography, comprises: an image forming portion including the photoreceptor drum on which a toner image is formed based on the electrostatic latent image formed thereon; a developing portion having a developing roller for supplying toner to the photoreceptor drum; a recording medium conveyor for conveying a recording medium toward the photoreceptor drum; a controller for controlling the drive of the recording medium conveyor; and a transfer portion for transferring the toner image formed on the photoreceptor drum to the recording medium being conveyed, and is characterized in that the recording medium conveyor conveys the recording medium in such a manner that the leading end of the recording medium collides with the photoreceptor drum; the controller includes: an eccentricity detector for detecting the eccentric variation of the peripheral surface of the photoreceptor drum; and a phase detector for detecting the rotational phase of the photoreceptor drum; and the controller corrects the timing of driving the recording medium conveyor based on the eccentric variation detected by the eccentricity detector and the rotational phase detected by the phase detector.

The second aspect of the invention resides in the image forming apparatus having the above first aspect, wherein the recording medium conveyor is constructed so that drive force is transmitted thereto in an intermittent manner by way of an electromagnetic clutch.

The third aspect of the invention resides in the image forming apparatus having the above first or second aspect, wherein the detected eccentric variations and rotational phases are stored in part of the image forming apparatus.

The fourth aspect of the invention resides in the image forming apparatus having any one of the above first to third aspects, wherein the eccentricity detector detects the peripheral surface of the photoreceptor drum at an end part thereof.

The fifth aspect of the invention resides in the image forming apparatus having any one of the above first to fourth aspects, wherein the eccentricity detector is an optical sensor.

The sixth aspect of the invention resides in the image forming apparatus having the above fifth aspect, wherein the eccentricity detector is a reflection type sensor.

The seventh aspect of the invention resides in the image forming apparatus having the above fifth or sixth aspect, wherein the eccentricity detector is arranged opposing the photoreceptor drum at a position on the upstream side of the developing roller with respect to the rotational direction of the photoreceptor drum.

The eighth aspect of the invention resides in the image forming apparatus having any one of the above fifth to seventh aspects, wherein the eccentricity detector performs detection using the front side region in the detection range of the eccentricity detector.

The ninth aspect of the invention resides in the image forming apparatus having any one of the above fifth to eighth aspects, wherein rotational phase reference information is provided in part of an area under detection on the photoreceptor drum to be detected by the eccentricity detector, and the eccentricity detector has a function of detecting the rotational phase of the photoreceptor drum.

The tenth aspect of the invention resides in the image forming apparatus having the above ninth aspect, wherein the controller assumes the eccentric variation in the area under detection at the position where the rotational phase reference information is given, to be the value that is obtained by multiplying (−1) into the value of the eccentric variation in the area under detection at the position that is located 180° with respect to the rotational direction of the photoreceptor drum, apart from the position where the rotational phase reference information is disposed.

The eleventh aspect of the invention resides in the image forming apparatus having any one of the above first to tenth aspects, the controller causes the eccentricity detector to detect the eccentric variation at each phase over the whole circumferential surface of the photoreceptor drum a multiple number of times, and regards the average of the measurements as the eccentric variation of the photoreceptor drum's peripheral surface at that phase.

The twelfth aspect of the invention resides in the image forming apparatus having any one of the above first to eleventh aspects, wherein the phase detector detects the rotational phase of the position from which image data starts to be written in.

The thirteenth aspect of the invention resides in the image forming apparatus having the above first aspect, wherein the controller corrects the timing based on the eccentric variation, the rotational phase and recording medium information.

The fourteenth aspect of the invention resides in the image forming apparatus having the above thirteenth aspect, wherein the recording medium information is the recording medium information on the recording medium that has been conveyed previously.

The fifteenth aspect of the invention resides in the image forming apparatus having the above thirteenth aspect, wherein the recording medium information includes the length information of the recording medium.

The sixteenth aspect of the invention resides in the image forming apparatus having the above thirteenth aspect, wherein the controller includes a recording medium rear end detector, and the recording medium information is the timing at which the rear end of the recording medium is detected by the recording medium rear end detector.

The seventeenth aspect of the invention resides in the image forming apparatus having the above first aspect, wherein the controller corrects the timing based on the eccentric variation, the rotational phase and process speed information.

The eighteenth aspect of the invention resides in the image forming apparatus having the above seventeenth aspect, wherein the controller corrects the timing based on the eccentric variation, the rotational phase and print number information.

The nineteenth aspect of the invention resides in the image forming apparatus having the above first aspect, wherein the eccentricity detector is a magnetic sensor.

According to the twentieth aspect of the invention, an image forming apparatus that is controlled so as to transfer a toner image formed on the peripheral surface of a photoreceptor drum to a recording medium by electrophotography, comprises: an image forming portion including the photoreceptor drum on which a toner image is formed based on the electrostatic latent image formed thereon; a developing portion having a developing roller for supplying toner to the photoreceptor drum; a recording medium conveyor for conveying a recording medium toward the photoreceptor drum; a controller for controlling the drive of the recording medium conveyor; and a transfer portion for transferring the toner image formed on the photoreceptor drum to the recording medium being conveyed, and is characterized in that the recording medium conveyor conveys the recording medium in such a manner that the leading end of the recording medium collides with the photoreceptor drum; the controller includes a phase detector for detecting the rotational phase of the photoreceptor drum; and the controller corrects the timing of driving the recording medium conveyor based on the rotational phase detected by the phase detector and based on the acquired photoreceptor drum correcting information including eccentricity information on the peripheral surface of the photoreceptor drum and the rotational phase information of the photoreceptor drum.

In the present invention, the photoreceptor drum correcting information includes the rotational phase of the photoreceptor drum, the eccentric variation, paper colliding position at which the paper collides with the photoreceptor drum, angular variation from the normal position when the paper collides with the eccentric position, image deviation distance, deviation time for the registration roller actuating timing and the like, at the position corresponding to the rotational phase.

Examples of the method of acquiring the photoreceptor drum correcting information in the present invention include acquisition of information from an IC chip, reading of a barcode that records information and is provided on the photoreceptor drum, reading of a barcode that records information and is provided on a box or the like for packaging the photoreceptor drum, and the operator's input of photoreceptor drum's information.

The twenty-first aspect of the invention resides in the image forming apparatus having the above twentieth aspect, wherein the recording medium conveyor is constructed so that drive force is transmitted thereto in an intermittent manner by way of an electromagnetic clutch.

The twenty-second aspect of the invention resides in the image forming apparatus having the above twentieth or twenty-first aspects, wherein the photoreceptor drum correcting information is stored in part of the image forming apparatus.

The twenty-third aspect of the invention resides in the image forming apparatus having any one of the above twentieth to twenty-second aspects, wherein the phase detector is an optical sensor.

The twenty-fourth aspect of the invention resides in the image forming apparatus having any one of the above twentieth to twenty-third aspects, wherein an optical sensor is used as an acquirer for acquiring the photoreceptor drum correcting information.

The twenty-fifth aspect of the invention resides in the image forming apparatus having the above twenty-fourth aspect, wherein the phase detector has a function of the acquirer.

The twenty-sixth aspect of the invention resides in the image forming apparatus having any one of the above twenty-third to twenty-fifth aspects, wherein the phase detector is a reflection type sensor.

The twenty-seventh aspect of the invention resides in the image forming apparatus having any one of the above twenty-third to twenty-sixth aspects, wherein the phase detector is arranged opposing the photoreceptor drum at a position on the upstream side of the developing roller with respect to the rotational direction of the photoreceptor drum.

The twenty-eighth aspect of the invention resides in the image forming apparatus having any one of the above twentieth to twenty-seventh aspects, wherein the phase detector detects the rotational phase of the position from which image data starts to be written in.

The twenty-ninth aspect of the invention resides in the image forming apparatus having the above twentieth aspect, wherein the controller corrects the timing based on the rotational phase, the photoreceptor drum correcting information and recording medium information.

The thirtieth aspect of the invention resides in the image forming apparatus having the above twenty-ninth aspect, wherein the recording medium information includes the length information of the recording medium.

The thirty-first aspect of the invention resides in the image forming apparatus having the above twenty-ninth aspect, wherein the controller includes a recording medium rear end detector, and the recording medium information is the timing at which the rear end of the recording medium is detected by the recording medium rear end detector.

The thirty-second aspect of the invention resides in the image forming apparatus having the above twentieth aspect, wherein the controller corrects the timing based on the eccentric variation, the rotational phase and process speed information.

The thirty-third aspect of the invention resides in the image forming apparatus having the above twentieth aspect, wherein the controller corrects the timing based on the eccentric variation, the rotational phase and print number information.

In accordance with the first aspect of the present invention, it is possible to place the leading end of the recording medium being conveyed toward the photoreceptor drum in register without being affected by the eccentricity and rotational phase of the photoreceptor drum. Accordingly, it is possible to prevent a timing difference from occurring due to the eccentricity of the photoreceptor drum, hence improve the positional accuracy in image transfer. As a result, it is possible to markedly effectively prevent, for example image misregistration to the paper in borderless printing and prevent color misregistration between color developers in color printing, which are prone to be affected by the eccentricity of the photoreceptor drum.

In accordance with the second aspect of the present invention, in addition to the effect obtained from the first aspect, it is possible to drive the recording medium conveyor exactly with a simple structure.

In accordance with the third aspect of the present invention, in addition to the effect obtained from the first or second aspect, it is possible to adjust the transfer timing depending on the position of the toner image formed on the photoreceptor drum, in a simple manner based on the recorded eccentric variations and rotational phases of the photoreceptor drum.

In accordance with the fourth aspect of the present invention, in addition to the effect obtained from the first to third aspects, it is possible to detect the eccentricity of the photoreceptor drum without exerting any influence on the image (toner image) formed in the predetermined area of the photoreceptor drum.

The photoreceptor drum according to the present invention includes one having a void area (empty area) outside (on one side or on both sides of) the toner forming area with respect to the axial direction.

In accordance with the fifth aspect of the present invention, in addition to the effect obtained from the first to fourth aspects, it is possible to detect the eccentricity of the photoreceptor drum with a simple structure.

In accordance with the sixth aspect of the present invention, in addition to the effect obtained from the fifth aspect, it is possible to configure the apparatus in a space-saving manner.

In accordance with the seventh aspect of the present invention, in addition to the effect obtained from the fifth or sixth aspect, it is possible to achieve correct detection of the eccentric variation by preventing the eccentricity detector from being dirtied by the falling toner that is supplied from the developing roller.

In accordance with the eighth aspect of the present invention, in addition to the effect obtained from the fifth to seventh aspects, it is possible to detect the eccentric variation with a higher precision.

In accordance with the ninth aspect of the present invention, in addition to the effect obtained from the fifth to eighth aspects, it is possible to reduce the number of the machine components because the eccentricity detector is adapted to also serve as the phase detector. Hence it is possible to realize a low-cost and space-saving apparatus configuration.

In accordance with the tenth aspect of the present invention, in addition to the effect from the ninth aspect, it is possible to prevent the lack of eccentricity data because the eccentricity data at the index marking portion can be compensated.

In accordance with the eleventh aspect of the present invention, in addition to the effect obtained from the first to tenth aspects, it is possible to obtain correct eccentric variation data by excluding the influence of the variance in the measurement due to noise etc.

In accordance with the twelfth aspect of the present invention, in addition to the effect obtained from the first to eleventh aspects, it is possible to determine the rotational phase of the paper lead colliding position uniformly, from the rotational phase of the position from which the image starts to be written in.

In accordance with the thirteenth to sixteenth aspects of the present invention, it is possible to readily determine the positions (transfer reference positions) on the photoreceptor drum which the leading ends of the second sheet and afterward abut.

In accordance with the seventeenth and eighteenth aspects of the present invention, it is possible to correct the transfer timing in accordance with the change of the processing speed.

In accordance with the nineteenth aspect of the present invention, it is possible to perform stable detection over a long period of time without being exerted by the toner or electrostatic latent image on the photoreceptor drum.

In accordance with the twentieth aspect of the present invention, it is possible to place the leading end of the recording medium being conveyed toward the photoreceptor drum in register without being affected by the eccentricity and rotational phase of the photoreceptor drum. Accordingly, it is possible to prevent a timing difference from occurring due to the eccentricity of the photoreceptor drum, hence improve the positional accuracy in image transfer. As a result, it is possible to markedly effectively prevent, for example image misregistration to the paper in borderless printing and prevent color misregistration between color developers in color printing, which are prone to be affected by the eccentricity of the photoreceptor drum.

In accordance with the twenty-first aspect of the present invention, in addition to the effect from the twentieth aspect, it is possible to drive the recording medium conveyor exactly with a simple structure.

In accordance with the twenty-second aspect of the present invention, in addition to the effect from the twentieth or twenty-first aspect, it is possible to adjust the transfer timing depending on the position of the toner image formed on the photoreceptor drum in a simple manner, based on the recorded eccentric variations and rotational phases of the photoreceptor drum.

In accordance with the twenty-third aspect of the present invention, in addition to the effect from the twentieth to twenty-second aspects, it is possible to detect the rotational phase of the photoreceptor drum with a simple structure.

In accordance with the twenty-fourth aspect of the present invention, since eccentricity information and rotational phase information are recorded as a barcode on the photoreceptor drum, for example, in addition to the effect from the twentieth to twenty-third aspects it is possible to acquire the information simply by reading the barcode.

In accordance with the twenty-fifth aspect of the present invention, in addition to the effect from the twenty-fourth aspect, it is possible to reduce the number of the machine components because the phase detector is adapted to also serve as the acquirer. Hence it is possible to realize a low-cost and space-saving apparatus configuration.

In accordance with the twenty-sixth aspect of the present invention, in addition to the effect from the twenty-third to twenty-fifth aspects, it is possible to configure the apparatus in a space-saving manner.

In accordance with the twenty-seventh aspect of the present invention, in addition to the effect from the twenty-third to twenty-sixth aspects, it is possible to achieve correct detection of the rotational phase of the photoreceptor drum by preventing the phase detector from being dirtied by the falling toner that is supplied from the developing roller.

In accordance with the twenty-eighth aspect of the present invention, in addition to the effect from the twenty to twenty-seventh aspects, it is possible to determine the rotational phase of the paper lead colliding position uniformly, from the rotational phase of the position from which the image starts to be written in.

In accordance with the twenty-ninth to thirty-first aspects of the present invention, it is possible to readily determine the positions (transfer reference positions) on the photoreceptor drum which the leading ends of the second sheet and afterward abut.

In accordance with the thirty-second and thirty-third aspects of the present invention, it is possible to correct the transfer timing in accordance with the change of the processing speed.

### BRIEF DESCRIPTION OF THE DRAWINGS

FIG. 1 is an illustrative view showing an overall configuration of an image forming apparatus according to the embodiment of the present invention;

FIG. 2 is a partial detailed view showing the configuration of the apparatus body of the image forming apparatus;

FIG. 3 is an illustrative view showing a state of paper being conveyed by a registration roller in the image forming apparatus;

FIG. 4 is an illustrative view showing a detection area to be detected by an eccentricity/phase sensor, on the peripheral surface of a photoreceptor drum according to the first embodiment;

FIG. 5A is a data table showing the output voltage detected by the eccentric/phase sensor in relation with the detection distance from the sensor;

FIG. 5B is a graph showing the detection sensitivity in the detection range of the eccentricity/phase sensor;

FIG. 6 is a block diagram showing a configuration of an electric controller of the image forming apparatus;

FIG. 7 is a block diagram showing one configurational example of a drive controller for the above electric controller;

FIG. 8A is a data table showing the rotational phases detected by the eccentricity/phase sensor according to the first embodiment, the sensor output voltages, average sensor output voltages, eccentric variations of the photoreceptor drum, positions at which the paper collides with the photoreceptor drum, angular variations, deviation distances and time deviations, at the corresponding detected rotational phases and positions;

FIG. 8B is a graph showing the relationship between the detected rotational phases and sensor output voltages;

FIG. 9A is a data table showing the rotational phases detected by the eccentricity/phase sensor according to the first embodiment, the sensor output voltages, average sensor output voltages, eccentric variations of the photoreceptor drum and positions at which the paper collides with the photoreceptor drum, at the corresponding detected rotational phases and positions;

FIG. 9B is a graph showing the relationship between the detected rotational phases and sensor output voltages;

FIG. 10 is an illustrative view showing a detection area to be detected by a phase sensor, on the peripheral surface of a photoreceptor drum according to the second embodiment;

FIG. 11A is a data table showing the output voltages detected by the phase sensor, in relation with the detection distance from the sensor;

FIG. 11B is a graph showing the detection sensitivity in the detection range of the phase sensor;

FIG. 12 is a block diagram showing a configuration of an electric controller of an image forming apparatus in accordance with the second embodiment;

FIG. 13A is a data table showing photoreceptor drum correcting information recorded in a barcode in accordance with the second embodiment;

FIG. 13B is a graph showing the relationship between the rotational angle and output voltage recorded in a barcode; and

FIG. 14 is a data table showing one example of a “correction table” for making up for the influence from the eccentricity of a photoreceptor drum as a variational example of the present embodiment.

### DESCRIPTION OF THE PREFERRED EMBODIMENTS

### The First Embodiment

The embodiment of the present invention will hereinafter be described in detail with reference to the drawings.

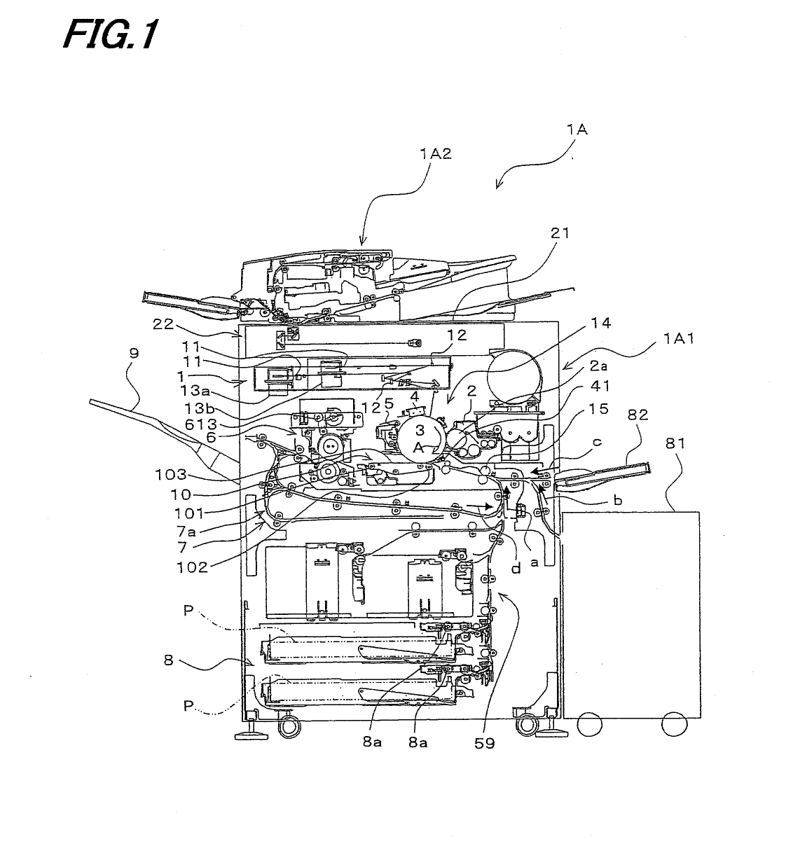

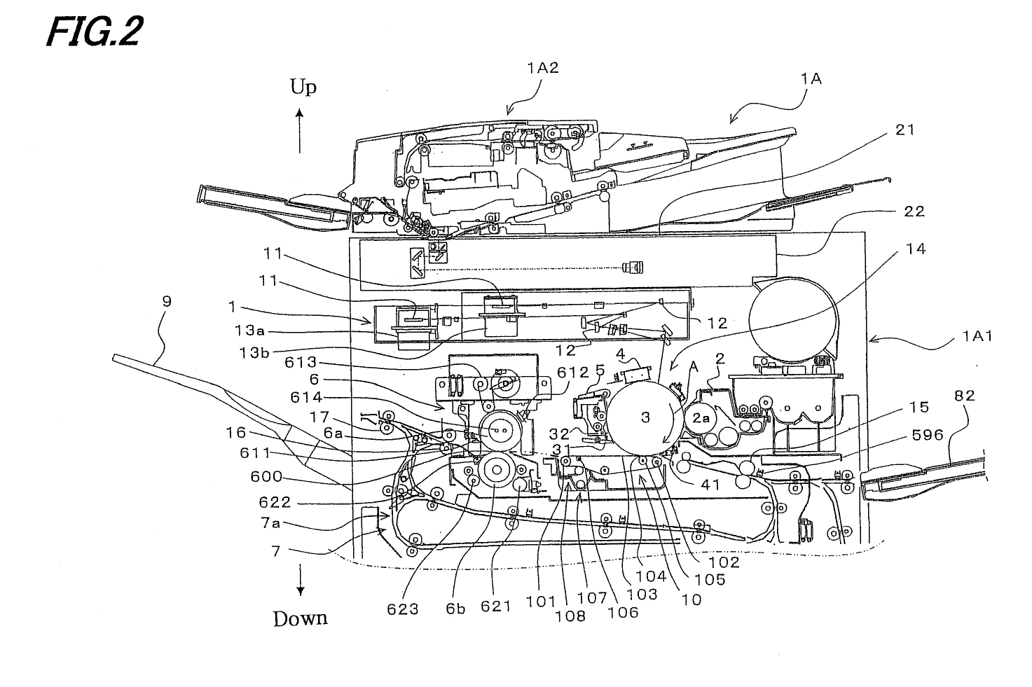

FIG. 1 is an illustrative view showing an overall configuration of an image forming apparatus using a paper feed mechanism according to the present invention. FIG. 2 is a partial detailed view showing the configuration of the apparatus body of the image forming apparatus.

Image forming apparatus 1A according to the present embodiment is to form and output a monochrome image on a recording medium, or a predetermined sheet of recording paper (which will be referred to hereinbelow as paper) by electrophotography in accordance with image data captured by a scanner or the like or image data transferred from without.

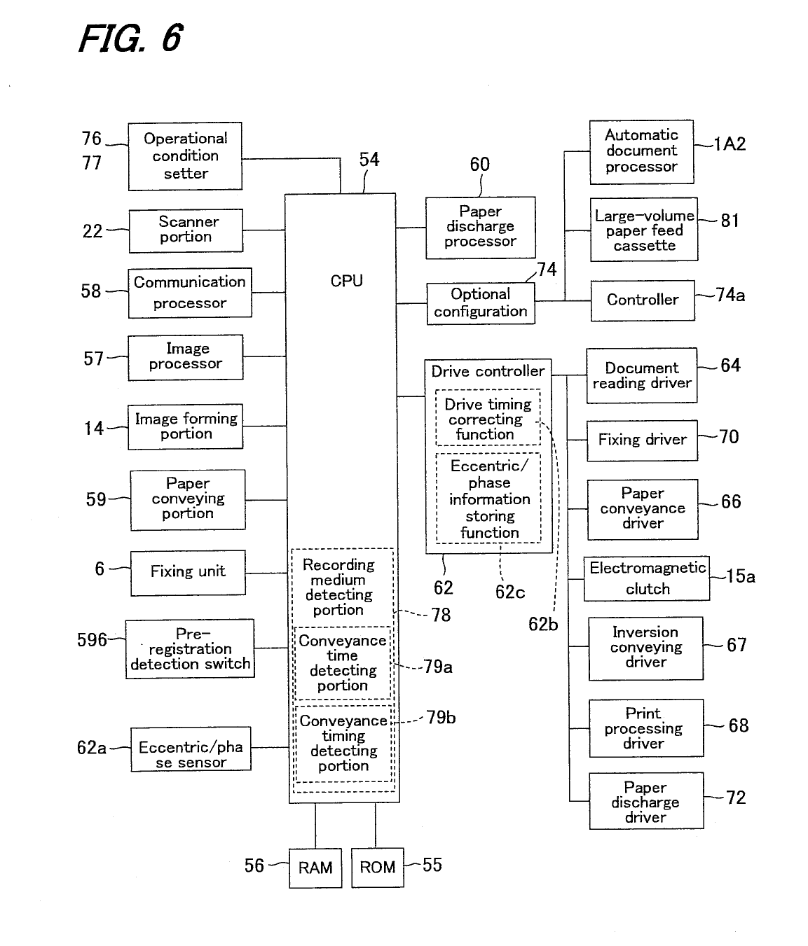

Image forming apparatus 1A includes an image forming portion 14, a developing unit (developing portion) 2, a registration roller (recording medium conveyor) 15 and a drive controller (controller) 62 (see FIG. 6).

Image forming portion 14 includes a photoreceptor drum 3 on which an electrostatic latent image is formed so as to produce a toner image based on the electrostatic latent image.

Developing unit 2 includes a developing roller 2a for supplying toner to photoreceptor drum 3.

Registration roller 15 conveys paper (recording medium) P toward photoreceptor drum 3.

Drive controller 62 controls the drive of this registration roller 15.

In image forming apparatus 1A which is controlled so that the toner image formed on the cylindrical surface (which will be referred to hereinbelow as “peripheral surface”) of photoreceptor drum 3 by electrophotography is transferred to paper P, if photo receptor drum 3 is positioned eccentrically with respect to the rotational axis, the timing of paper feed by registration roller 15 is corrected in conformity with the eccentric variation.

To begin with, the overall configuration of image forming apparatus 1A according to the present embodiment will be described.

Image forming apparatus 1A is essentially composed of, as shown in FIGS. 1 and 2, an apparatus body 1A1 including a light exposure unit 1, developing unit (developing portion) 2, photoreceptor drum 3, a charger 4, a charge erasing device 41, a cleaner unit 5, a fixing unit 6, a paper conveyor system 7, a paper feed tray 8, a paper output tray 9, a transfer device (transfer portion) 10 and the like, and an automatic document processor 1A2.

Provided at the top of apparatus body 1A1 is an original placement table 21 made of transparent glass on which a document is placed. Automatic document processor 1A2 is arranged on the top of this original placement table 21 so that it can pivotally open upwards while a scanner portion 22 as a document reader for reading image information of originals is arranged under this original placement table 21.

Arranged below scanner portion 22 are light exposure unit 1, developing unit 2, photoreceptor drum 3, charger 4, charge erasing device 41, cleaner unit 5, fixing unit 6, paper conveyor system 7, paper output tray 9 and transfer device 10. Further, paper feed tray 8 that accommodates paper P therein is arranged under these.

Light exposure unit 1 illuminates the peripheral surface of photoreceptor drum 3 which has been uniformly electrified by charger 4, with laser beams in accordance with the image data (printing image information) output from an unillustrated image processor. With this exposure of light, an electrostatic latent image in accordance with the image data is written on the peripheral surface of photoreceptor drum 3.

Light exposure unit 1 is arranged directly under scanner portion 22 and above photoreceptor drum 3. Light exposure unit 1 adopts laser scanning units (LSUs) 13a and 13b including laser emitters 11 and a reflection mirror 12. In the present embodiment, in order to achieve high-speed printing operation, multiple laser beams are used to reduce the irradiation frequency of each laser beam. That is, a two-beam technique is adopted.

Here, in the present embodiment laser scanning units (LSUs) 13a and 13b are used for light exposure unit 1, but an array of light emitting elements, e.g., an EL (electro luminescence) or LED (light-emitting diode) writing head may also be used.

As shown in FIG. 2, photoreceptor drum 3 has an approximately cylindrical shape and is arranged under light exposure unit 1. Photoreceptor drum 3 is controlled so as to rotate in a predetermined direction (in the direction of arrow A in the drawing) by an unillustrated driver and controller. Arranged along the peripheral surface of this photoreceptor drum 3, starting from the position at which image transfer ends downstream in the rotational direction of the photoreceptor drum are a paper separation claw 31, cleaner unit 5, charger 4 as an electric field generator, developing unit 2 and charge erasing device 41 in the order mentioned.

Paper separation claw 31 is disposed so as to be moveable into and out of contact with the peripheral surface of photoreceptor drum 3 by means of a solenoid 32. When this paper separation claw 31 is put in abutment with the peripheral surface of photoreceptor drum 3, it peels off the paper P that has adhered to the photoreceptor drum 3 surface after the unfixed toner image on photoreceptor drum 3 has been transferred to the paper P.

Here, as a driver for paper separation claw 31, a drive motor or the like may be used instead of solenoid 32, or any other driver may also be selected.

Developing unit 2 visualizes the electrostatic latent image formed on photoreceptor drum 3 with black toner, and is arranged at approximately the same level at the side (on the right side in the drawing) of photoreceptor drum 3 downstream of charger 4 with respect to the rotational direction of the photoreceptor drum (in the direction of arrow A in the drawing). Registration roller 15 is disposed under this developing unit 2. Registration roller 15 is disposed on the upstream side of transfer device 10 with respect to the recording medium's direction of conveyance.

Registration roller 15 feeds paper P delivered from paper feed tray 8 toward photoreceptor drum 3 or into the nip between photoreceptor drum 3 and transfer belt 103 in such timing as to make the predetermined position in the printing area in paper P register with the toner image on photoreceptor drum 3. Registration roller 15 is operated and controlled by an unillustrated driver and controller.

As the definition of the terms, the position on the peripheral surface of photoreceptor drum 3 against which leading end of paper P should abut in order to achieve the aforementioned registration will be referred to as “transfer reference position”.

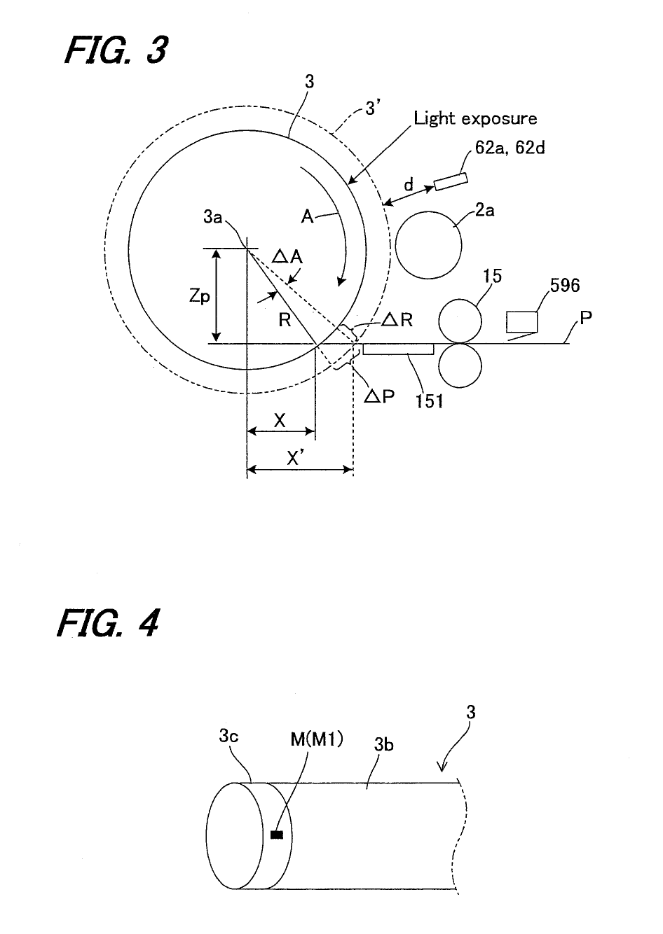

When, for example, bordered printing (with margins) is performed or when printing is not performed from the leading end of the printing area on paper P, the transfer reference position will be located at a position downstream of the toner image on photoreceptor drum 3 with respect to rotational direction A (FIG. 3) of photoreceptor drum 3. On the other hand, when printing is performed from the leading end of the printing area on paper in a case of borderless printing, i.e., when printing is performed over the entire surface of paper P, the transfer reference position will be located at the leading position of the toner image on photoreceptor drum 3.

Charger 4 is a charging device for uniformly charging the peripheral surface of photoreceptor drum 3 at a predetermined potential. Charger 4 is arranged over photoreceptor drum 3 and close to the peripheral surface thereof.

Here, a discharge type charger 4 is used in the present embodiment, but a contact roller type or a brush type may be used instead.

Charge erasing device 41 is a pre-transfer erasing device for lowering the surface potential on the peripheral surface of the photoreceptor drum 3 in order to facilitate the toner image formed on the peripheral surface of photoreceptor drum 3 to transfer to paper P. Charge erasing device 41 is laid out on the downstream side of developing unit 2 with respect to the photoreceptor drum's direction of rotation and under photoreceptor drum 3 and close to the peripheral surface of the same.

Though in the present embodiment, charge erasing device 41 is configured using a charge erasing electrode, a charge erasing lamp or any other method can be used instead of the charge erasing electrode.

Cleaner unit 5 removes and collects the toner left on the peripheral surface of photoreceptor drum 3 after development and image transfer. Cleaner unit 5 is disposed at approximately the same level at the side of photoreceptor drum 3 (on the left side in the drawing), on the approximately opposite side across photoreceptor drum 3 from developing unit 2.

With the arrangement described above, the visualized electrostatic image (visualized image) on photoreceptor drum 3 is transferred to the paper P being conveyed into and between photoreceptor drum 3 and transfer belt 103 whilst the paper is being applied by transfer device 10 with an electric field having an opposite polarity to that of the electric charge on the electrostatic image. For example, when the visualized image bears negative (−) charge, the applied polarity of transfer device 10 should be positive (+).

Transfer device 10 is provided as a transfer belt unit in which transfer belt 103 is arranged. As shown in FIG. 2 transfer belt 103 is wound and tensioned on a drive roller 101, a driven roller 102 and other rollers and has a predetermined resistivity (ranging from 1×10⁹ to 1×10¹³ Ω·cm in the embodiment).

Transfer device 10 is disposed under photoreceptor drum 3 with the transfer belt 103 surface put in contact with part of the peripheral surface of photoreceptor drum 3. Transfer device 10 conveys paper P while pressing the paper against photoreceptor drum 3 by this transfer belt 103.

An elastic conductive roller 105 having a conductivity different from that of drive roller 101 and driven roller 102 and capable of applying a transfer electric field is laid out at a contact portion 104 between photoreceptor drum 3 and transfer belt 103.

Elastic conductive roller 105 is composed of a soft material such as elastic rubber, foamed resin etc. Since this elasticity of elastic conductive roller 105 permits photoreceptor drum 3 and transfer belt 103 to come into, not line contact, but area contact of a predetermined width (called a transfer nip) with each other, it is possible to improve the efficiency of transfer to the paper P being conveyed.

Elastic conductive roller 105 is applied with a transfer voltage having an opposite polarity to that of the visualized image so as to apply a transfer electric field to paper P over transfer belt.

Further, a charge erasing roller 106 for erasing the electric field that has been applied to the paper P as it was being conveyed through the transfer area so as to achieve smooth conveyance of the paper to the subsequent stage is disposed on the interior side of transfer belt 103, on the downstream side of the transfer area of transfer belt 103 with respect to the direction of paper conveyance.

Transfer device 10 also includes a cleaning unit 107 for removing dirt due to leftover toner on transfer belt 103 and a plurality of charge erasing devices 108 for erasing electricity on transfer belt 103. Erasure of charge by erasing devices 108 may be performed by grounding via the apparatus or by positively applying charge of a polarity opposite to that of the transfer field.

Paper P with a static image (unfixed toner) transferred thereon by transfer device 10 is conveyed to fixing unit 6, where it is pressed and heated so as to fuse the unfixed toner and fix it to the paper P.

Fixing unit 6 includes a heat roller 6a and a pressing roller 6b as shown in FIG. 2. Fixing unit 6 fuses and fixes the toner image transferred on paper P by rotating heat roller 6a so as to convey the paper P held between heat roller 6a and pressing roller 6b through the nip there between. Arranged on the downstream side of fixing unit 6 with respect to the paper feed direction is a conveyance roller 16 for conveying paper P.

Heat roller 6a has a sheet separation claw 611, a thermistor 612 as a roller surface temperature detector and a roller surface cleaning member 613, all arranged on the periphery thereof and also includes a heat source 614 for heating the heat roller surface at a predetermined temperature (set fixing temperature: approximately 160 to 200 deg. C.) in the interior part thereof.

Pressing roller 6b is provided at its each end with a pressing element 621 capable of pressing pressing roller 6b with a predetermined pressure against heat roller 6a. In addition a sheet separation claw 622 and a roller surface cleaning element 623 are provided on the periphery of pressing roller 6b, similarly to the periphery of heat roller 6a.

In this fixing unit 6, as shown in FIG. 2 the unfixed toner on the paper P being conveyed is heated and fused by heat roller 6a at the pressed contact (so-called fixing nip portion) 600 between heat roller 6a and pressing roller 6b, so that the unfixed toner is fixed to the paper P by the anchoring effect to the paper P by the pressing force from heat roller 6a and pressing roller 6b.

Paper feed tray 8 (FIG. 1) stacks a plurality of sheets (paper) to which image information will be output (printed). Paper feed tray 8 is arranged under image forming portion 14 made up of light exposure unit 1, developing unit 2, photoreceptor drum 3, charger 4, charge erasing device 41, cleaner unit 5, fixing unit 6 etc. A paper pickup roller 8a is disposed at an upper part on the paper output side of this paper feed tray 8.

This paper pickup roller 8a picks up paper P, sheet by sheet, from the topmost of a stack of paper stored in paper feed tray 8 and conveys the paper to registration roller (also called “idle roller”) 15 side.

Since the image forming apparatus 1A according to the present embodiment is aimed at performing high-speed print processing, a multiple number of paper feed trays 8 each capable of stacking 500 to 1500 sheets of standard-sized paper P are arranged under the image forming apparatus while a large-capacity paper feed cassette 81 capable of storing multiple kinds of paper in large volumes is arranged at the side of the apparatus. Further, a manual feed tray 82 for essentially supporting for irregular sized printing paper is arranged over the large-capacity paper feed cassette 81.

Paper output tray 9 is arranged on the opposite side across the apparatus from manual feed tray 82. It is also possible to provide, instead of paper output tray 9, a post-processing machine for output paper (devices for stapling, punching) and/or a multi-bin paper output tray etc., as an option.

Next, a characteristic configuration of the drive control of registration roller 15 in image forming apparatus 1A will be described with reference to the drawings.

FIG. 3 is an illustrative view showing a state of paper being conveyed to the photoreceptor drum by a registration roller in the image forming apparatus according to the present invention.

As shown in FIG. 3, registration roller 15 feeds paper P in such a manner that the leading end of paper P being conveyed becomes in register with the transfer reference position on the peripheral surface of photoreceptor drum 3.

Further, registration roller 15 conveys paper P in such a direction that the leading end of paper P being conveyed collides with the cylindrical peripheral surface (transfer reference position) of photoreceptor drum 3. In other words, registration roller 15 conveys paper P so that the leading end of paper P abuts the photo receptor drum surface at a position on the upstream side of contact portion 104 (FIG. 2) with respect to photoreceptor drum's rotational direction A. Accordingly, paper P is conveyed along the peripheral surface after its abutment against the peripheral surface of photoreceptor drum 3, and in this while the visualized image on the peripheral surface of photoreceptor drum 3 is transferred to paper P. A guide portion 151 that assists in conveying paper is arranged between registration roller 15 and photoreceptor drum 3 along the paper feed direction.

Paper P is conveyed along guide portion 151 by registration roller 15, so that its leading end collides with the transfer reference position on photoreceptor drum 3.

In FIG. 3, with the rotational center, designated at 3a, of photoreceptor drum 3 assumed to be the origin of coordinates, the vertical direction the Z-axis and the horizontal direction the X-axis, the paper colliding position (the spatial position of collision of the leading end of paper P against the transfer reference position) is represented by the position X in the X-axis direction and the position Zp in the Z-axis direction (the paper colliding position is represented hereinbelow by the coordinates (the X-axis position and the Z-axis position). When printing is performed over the entire surface of paper P, the paper colliding position (X, Zp) coincides with the transfer reference position on the coordinates.

FIG. 4 is an illustrative view showing a detection area to be detected by an eccentricity/phase sensor, on the peripheral surface of the photoreceptor drum according to the first embodiment.

As shown in FIG. 4, on the peripheral surface of photoreceptor drum 3, an index marking (rotational phase reference information) M is formed at one end 3c on one side outside the area where the toner image is formed (toner image forming area) 3b with respect to the axial direction of photoreceptor drum 3.

An eccentricity/phase sensor (eccentricity detector, phase detector) 62a is arranged near the peripheral surface of photoreceptor drum 3 at a position so that it can detect marking M.

Eccentricity/phase sensor 62a has the function of detecting the displacement of the peripheral surface of photoreceptor drum 3, i.e., the eccentric variation of the peripheral surface relative to the rotational center (axis) 3a and the function of detecting the rotational phase of the photoreceptor drum 3.

Eccentricity/phase sensor 62a uses a reflection type optical sensor and is arranged opposing photoreceptor drum 3 at a position on the upstream side of developing roller 2a with respect to the rotational direction of photoreceptor drum 3. In the present embodiment where developing roller 2a is arranged on the right side of photoreceptor drum 3 rotating in the direction of arrow A as shown in FIG. 3, eccentricity/phase sensor 62a is arranged over developing roller 2a. This layout makes it possible for eccentricity/phase sensor 62a to perform correct detection without it being dirtied by the falling toner that is supplied from developing roller 2a to photoreceptor drum 3.

Eccentricity/phase sensor 62a is arranged opposing the end of photoreceptor drum 3 with respect to the axial direction thereof so as to detect marking M and the rotational phase of the transfer reference position relative tomarking M (which will be referred to hereinbelow as “transfer reference position's rotational phase”).

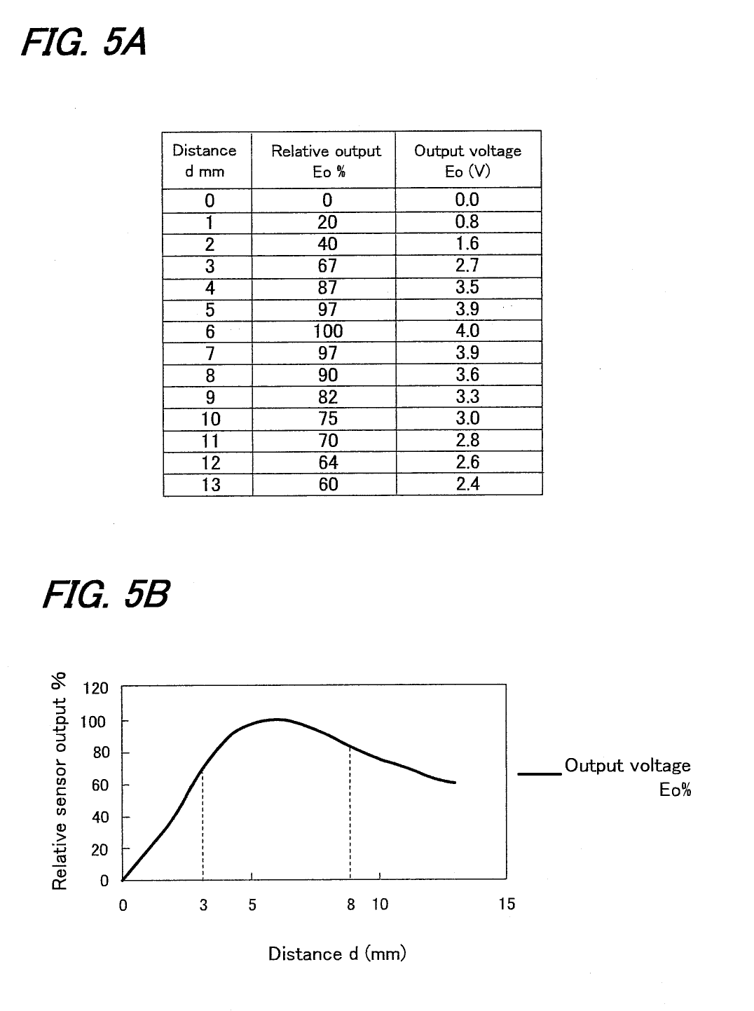

FIG. 5A is a data table showing the output voltage detected by the eccentric/phase sensor in relation with the detection distance from the sensor, and FIG. 5B is a graph showing the detection sensitivity in the detection range of the eccentricity/phase sensor.

As shown in FIG. 5A, in the detecting process of an object under detection by eccentricity/phase sensor 62a, output voltage EoV from eccentricity/phase sensor 62a is measured by changing the detecting distance d in 1 mm increments, and then relative output Eo % at each distance, the output voltage at each distance relative to the maximum output voltage, is calculated.

Eccentricity/phase sensor 62a is arranged so as to perform detection using the front side region in the detection range shown in FIG. 5B, specifically the region having a detecting distance ranging from 3 mm (or 4 mm) to 8 mm where the detection sensitivity rises. Use of this region for detection makes the detecting operation stable.

Here in the present embodiment, when the detecting distance d is 6 mm, the output voltage becomes maximum or takes a maximum output voltage Eo of 4.0V (relative output Eo % is set equal to 100%), where the detection sensitivity becomes most favorable.

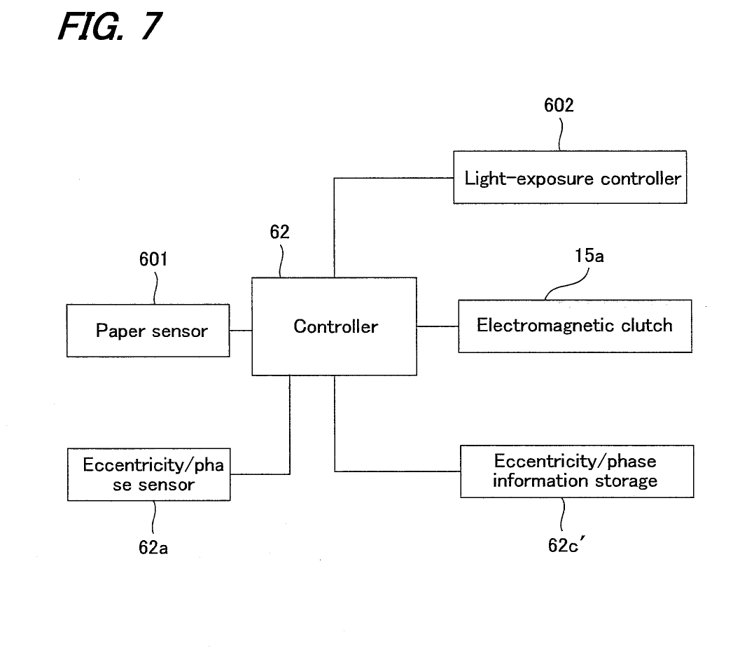

The eccentric variations for the whole circumference of photoreceptor drum 3 (eccentricity information) and rotational phase for the whole circumference (rotational phase information) detected by eccentricity/phase sensor 62a and the transfer reference position's rotational phase (transfer reference position's rotational phase information) are stored in part of image forming apparatus 1A, for example in an eccentricity/phase information storage 62c′ (FIG. 7).

Registration roller 15 can be driven in an intermittent manner using an electromagnetic clutch 15a (see FIG. 6). This electromagnetic clutch 15a is operated and controlled by an after mentioned drive controller 62 (see FIG. 6). Arranged on the upstream side of registration roller 15 with respect to the paper feed direction is a pre-registration detection switch 596 for detecting whether the paper reaches registration roller 15.

Next, the control system of image forming apparatus 1A according to the embodiment will be described with reference to the drawings.

FIG. 6 is a block diagram showing an electric controller configuration of the image forming apparatus according to the present embodiment.

As shown in FIG. 6, image forming apparatus 1A according to the embodiment processes such as image reading, image processing, image forming and conveyance of paper P, etc., by a central processing unit (CPU) 54 which performs control in accordance with the program stored beforehand in ROM (read only memory) 55, in cooperation with temporal storage such as RAM (random access memory) 56 etc.

Here, it is also possible to use other storages such as a HDD (hard disk drive) etc., instead of ROM 55 and RAM 56.

In image forming apparatus 1A, the image information of an original (original image data) captured by scanner portion 22, or original image information transmitted from other terminal devices connected via an unillustrated communication network, is adapted to be input to an image processing portion 57 by way of a communication processor 58.

Image processor 57 shapes the original image information stored in the storage such as RAM 56 or the like into a printing image that is suitable for printing (image forming onto paper), in accordance with the aforementioned program.

The printing image information is input to image forming portion 14.

Image forming portion 14, paper conveying portion (performing various detections and controls of paper in paper feed path 7a, etc.) 59, fixing unit 6 and paper discharge processor (performing various detections and controls of paper in paper discharge roller 17) 60 are linked with drive controller 62.

The paper conveyed by paper conveying portion 59 is led through the printing stage (the printing process of image information in image forming portion 14) and the fixing stage where the paper having been printed is fixed (in fixing unit 6) and then is discharged to paper discharge portion (paper output tray 9).

Here, paper conveying portion 59 receives detection signals from pre-registration detection switch 596, unillustrated fixing detection switch, paper discharge detection switch, etc.

The fixing detection switch is a switch for detecting whether the paper reaches fixing unit 6. The paper discharge detection switch is a switch for detecting whether the paper has been discharged.

Image forming apparatus 1A also includes an operational condition setter 77.

This operational condition setter 77 sets up the operational conditions for image forming and the conditions of conveyance etc., in image forming apparatus 1A, in accordance with the image forming request (e.g., the setting of the margins when bordered prints are formed) designated by the user through control switches 76 and/or the image forming conditions such as the type (sheet thickness) of recording media (paper) etc.

Further, in image forming apparatus 1A, in accordance with the set operational conditions (specifically, instructions and the like from CPU 54 based on the program stored in ROM 55), drive controller 62 controls the drive actuators for the document reader (scanner portion 22), paper conveying portion 59, image forming portion 14, fixing unit 6, paper discharge processor 60 etc., namely, a document reading driver 64, a paper conveyance driver 66, an inversion conveying driver 67, a print processing driver 68, a fixing driver 70 and a paper discharge driver 72, in synchronism.

Document reading driver 64 is the drive actuator for scanner portion 22.

Paper conveyance driver 66 means the drive motors for paper conveying portion 59, or paper pickup roller 8a and registration roller 15 along the aforementioned paper feed path 7a.

In the present embodiment, the drive motor for registration roller 15 is adapted to drive registration roller 15 by way of electromagnetic clutch 15a.

Inversion conveying driver 67 is the drive motor for inversion conveying roller 18.

Print processing driver 68 is the drive motor for photoreceptor drum 3.

Fixing driver 70 is the drive motor for heat roller 6a and pressing roller 6b in fixing unit 6.

Paper discharge driver 72 is the drive motor for paper discharge roller 17 and the like.

The drive motors for all these drivers may be provided as common or different drive motors with appropriate power transmission mechanisms.

Further, image forming apparatus 1A may be used with optional configurations 74 including post-processors (stapler, puncher, multi-bin paper output trays, shifter, etc.), automatic document reader (automatic document processor 1A2 etc.), large-volume paper feed cassette 81 and the like.

These optional configurations 74 incorporate individual controllers 74a separately from the controller of image forming apparatus 1A so that each processor can operate in synchronization by performing timing adjustment with the main apparatus 1A via the aforementioned communication processor 58.

A recording medium detecting portion 78 detects arrival of the leading end of the paper to fixing unit 6 or the output portion.

Specifically, recording medium detecting portion 78 includes a conveyance time detecting portion 79a and a conveyance timing detecting portion 79b.

Conveyance time detecting portion 79a measures the time of conveyance of the paper after the paper is delivered from registration roller 15.

Conveyance timing detecting portion 79b detects the timings at which the paper is conveyed in paper discharge path 7a, based on the distances from registration roller 15 to the objects to be controlled, i.e., fixing unit 6 and paper discharge drive roller 17 and based on the paper's speed of conveyance.

Recording medium detecting portion 78 in the present embodiment is adapted to detect the timings at which the paper arrives at (enter) fixing unit 6 and paper discharge roller 17, based on the conveyance timings of recording medium detected by conveyance timing detecting portion 79b.

In the present embodiment, drive controller 62 further includes a drive timing correcting function 62b and an eccentricity/phase information storage function 62c.

Drive timing correcting function 62b corrects the timing at which registration roller 15 is actuated by controlling the engaging and disengaging action of electromagnetic clutch 15a, based on the transfer reference position and the eccentric variation at the transfer reference position.

Eccentricity/phase information storage function 62c has a function of storing the transfer reference position's rotational phase (rotational phase information) detected by eccentricity/phase sensor 62a and the eccentric variation (eccentricity information) at that position and includes eccentricity/phase information storage 62c′ (FIG. 7) for storing the transfer reference position's rotational phase and the eccentric variation at that position.

That is, the operational control of the electromagnetic clutch by drive controller 62 and the paper feed timing control by registration roller 15 are performed based on the transfer reference position and the eccentric variation at the transfer reference position.

Further, drive controller 62 assumes the eccentric variation in the area under detection where the rotational phase reference information, e.g., index marking M is disposed, to be the value that is obtained by multiplying (−1) into the value of the eccentric variation in the area under detection that is located 180° with respect to the rotational direction of the photoreceptor drum, apart from the area where marking M is disposed.

Moreover, drive controller 62 causes eccentricity/phase sensor 62a to detect the eccentric variation at each phase over the whole circumferential surface of photoreceptor drum 3 a multiple number of times, and regards the average of the measurements as the eccentric variation of the photoreceptor drum 3's surface at the associated phase.

Next, the operational control of registration roller 15 by drive controller 62 will be described.

As shown in FIG. 7, drive controller 62 controls electromagnetic clutch 15a of registration roller 15 based on the signals from a paper sensor 601, variation/phase sensor 62a, an exposure controller 602 in image forming portion 14 and eccentricity/phase information storage 62c′.

Paper sensor 601 may be a sensor that also serves as the aforementioned preregistration detection switch 596. Exposure controller 602 is a component of image forming portion 14.

Now, one example of the operational control of registration roller 15 by drive controller 62 will be shown.

To begin with, different rotational phases along the whole circumferential surface of photoreceptor drum 3 with respect to marking M, the eccentric variations at each rotational phase are detected by eccentricity/phase sensor 62a, and the measurements are stored in eccentricity/phase information storage 62c′ as the eccentricity/phase information of photoreceptor drum 3.

Next, in printing on the first sheet of paper, after photoreceptor drum 3 is rotated by a predetermined time, light exposure for writing is started, and based on the detection of the rotational phase reference information, margin sizes and the like, the rotational phase of the first transfer reference position of the first sheet is determined so as to determine the eccentric variation at the first transfer reference position from the eccentricity/phase information stored in eccentricity/phase information storage 62c′.

Based on the thus obtained eccentric variation at the first transfer reference position, the timing at which electromagnetic clutch 15a for transmitting driving power to registration roller 15 for feeding the first sheet is engaged (turned on) is corrected.

When paper sensor 601 detects the rear end of the sheet being conveyed, the total length of the sheet (printing paper information) is determined. For printing the second sheet and thereafter, the position corresponding to the total sheet length added with a predetermined inter-sheet distance is the second transfer reference position, and the rotational phase of the second transfer reference position from the reference position is determined.

Then, light exposure is effected at the aforementioned exposure timing for the second sheet and thereafter while the coupling timings of the electromagnetic clutch 15a for the second sheet and thereafter are corrected based on the eccentric variations determined at the rotational phases at the second transfer reference position, third transfer reference position, . . . .

Alternatively, it is also possible to determine the rotational phases of the second transfer reference position and third transfer reference position, . . . for the second sheet and thereafter in the same manner as that for the first sheet, so as to correct the timings at which the electromagnetic clutch 15a is coupled for the second sheet and thereafter.

Next, detection of the amount of correction of the actuating timing of registration roller 15 depending on the eccentric variation of photoreceptor drum 3 will be described with reference to examples.

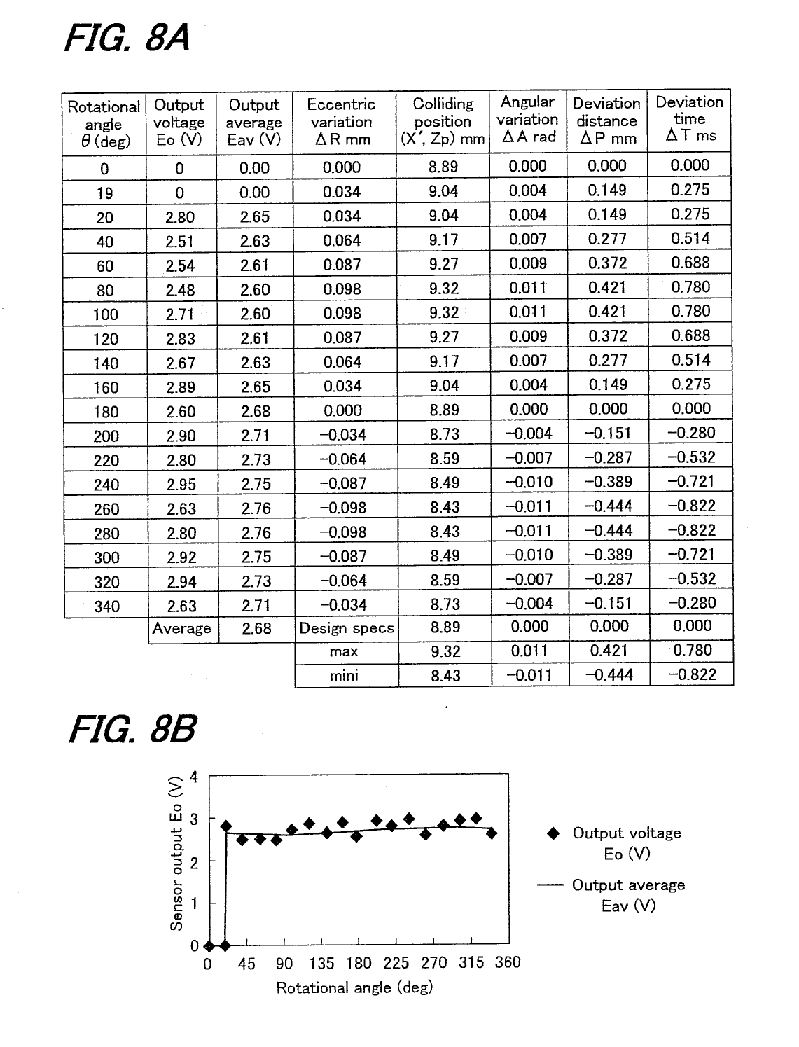

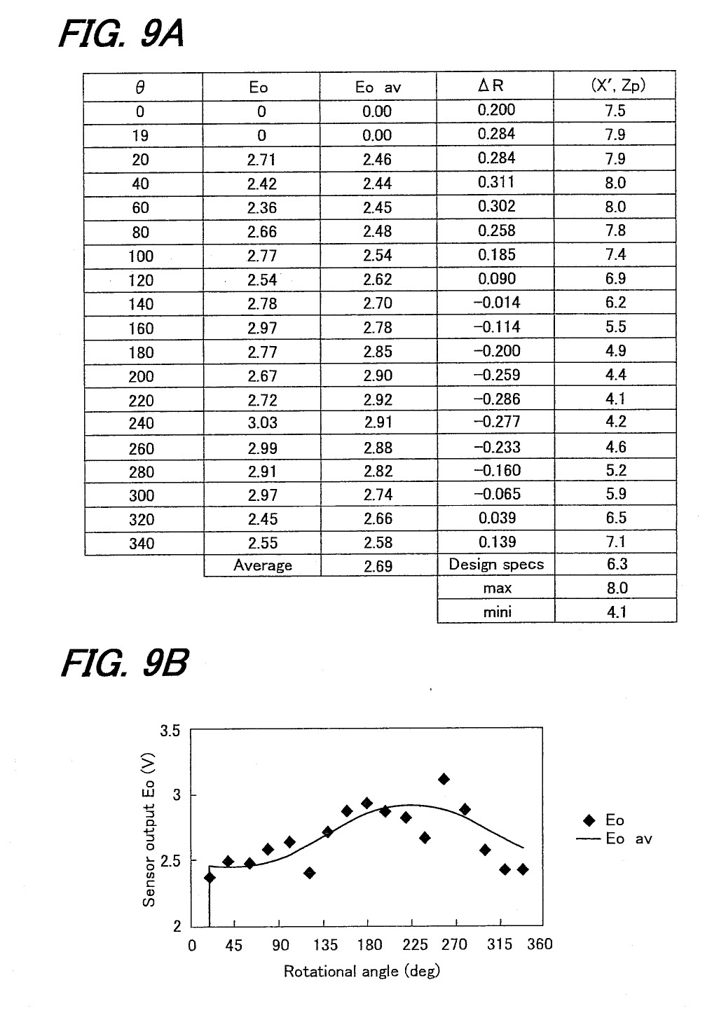

FIGS. 8A and 9A are data tables of individual photoreceptor drums, each showing the rotational phases detected by eccentricity/phase sensor 62a of the embodiment, the sensor output voltages, the average sensor output voltages, eccentric variations of the associated photoreceptor drum, positions at which the paper collides with the photoreceptor drum, angular variations, deviation distances and time deviations, at the corresponding detected rotational phases (in FIG. 9A, part of data is shown).

FIGS. 8B and 9B are graphs for the above two photoreceptor drums, each showing the relationship between the detected rotational phases and sensor output voltages as to the peripheral surface of the associated photoreceptor drum, detected by the eccentricity/phase sensor.

“The rotational phase, the sensor output voltage, the average sensor output voltage, the eccentric variation of the photoreceptor drum, the position at which the paper collides with the photoreceptor drum, the angular variation, the deviation distance and time deviation, at the detected rotational phase” may also be referred to in short as “photoreceptor drum correcting information”. The paper colliding position, angular variation, deviation distance and time deviation are determined by the following formulae (3) to (6).

As shown in FIG. 4, photoreceptor drum 3 of the present embodiment is formed of a cylinder having an outside diameter of 80 mm with its aluminum base (surface-roughened) exposed 10 mm wide at its end part 3c with respect to the axial direction for measurement of its eccentricity. A black marking M1 of a 10 mm square is formed at end part 3c.

As eccentricity/phase sensor 62a a reflection type photo interrupter (a product of Sharp Corporation: GP2S28) is used and laid out with a switchable clearance of 3.0 mm or 4.0 mm apart from the peripheral surface of photoreceptor drum 3.

First, the sensor output from eccentricity/phase sensor 62a at the time of detection is adjusted.

For this purpose, with photoreceptor drum 3 set stationary, the sensor output E₃ from eccentricity/phase sensor 62a when its clearance from photoreceptor drum 3 is set at 3.0 mm and the sensor output E₄ when the clearance is set at 4.0 mm are measured and then the clearance from photoreceptor drum 3 is fixed at 3.0 mm.

The sensor sensitivity α [mm/V] of eccentricity/phase sensor 62a in this case is calculated by the following formula (1).

α=1/(E₄−E₃) (1)

Then, while photoreceptor drum 3 is rotated at the normal processing speed, sensor output values Eo(θ) [V] are measured at rotational angles (rotational phases) every 20 degrees over the whole circumference of the photoreceptor drum, based on the rotational angle (rotational phase) at which black marking M1 is detected, as shown in FIGS. 8A and 9A. The measurement of the sensor output value (sensor output variation) Eo(θ) [V] at each angle is performed 32 times while the photoreceptor drum is being rotated 32 times, and the 32 measurements for each rotational angle θ are averaged to determine average value Eoav(θ)[V].

The relationship between the rotational phase of photoreceptor drum 3 and the sensor output from eccentricity/phase sensor 62a at the corresponding position is given by the graphs shown in FIGS. 8B and 9B. In the case of FIG. 8B, the sensor output curve changes its curvature at a rotational phase of 180°, to the opposite direction. That is, photoreceptor drum 3 is found to be eccentric. In the case of FIG. 9B, the sensor output curve changes its curvature at around a rotational phase of about 135°, to the opposite direction so that photoreceptor drum 3 is found to be eccentric.

When the radius of photoreceptor drum 3 is R, the eccentric variation ΔR(θ) [mm] of the peripheral surface of photoreceptor drum 3 is determined by the following formula (2):

Eccentric variation ΔR(θ)=α·Eoav(θ) (2).

From the measurement, photoreceptor drum 3 of FIG. 8A is found to be eccentric so that its maximum eccentric variation ΔR is 0.098 mm in the rotational phase range of 80° to 100° and −0.098 mm in the rotational phase range of 260° to 280°. On the other hand, photoreceptor drum 3 of FIG. 9A is found to be eccentric so that its maximum eccentric variation ΔR is 0.311 mm at a rotational phase of 40° and −0.286 mm at a rotational phase of 220°.

Here, the position at which paper P collides with the surface of a photoreceptor drum 3 having a normal shape (free from eccentricity) is represented as paper colliding position (X, Zp), and the position at which paper P collides with the surface of an eccentric photoreceptor drum 3′ (the portion represented by the two-dot chain line in FIG. 3) is represented as paper colliding position (X′, Zp) [mm]. The photoreceptor drum 3′ shown in FIG. 3 is exaggerated for illustrative purposes.

When the rotational angle is θ, the Z-axis position Zp [mm] of the paper colliding position (X′ (θ), Zp) at which the leading end of paper P collides with photoreceptor drum 3′ is set equal to 39.0 [mm] (downward) (Zp=39.0 [mm]). Therefore, the X-axis position X′ (θ) [mm] in the drawing can be given by the following formula (3):

X′ (θ)={(R+ΔR(θ))²−Zp²}^{0.5} (3).

Angular variation ΔA [rad] of paper colliding position (X′ (θ), Zp) is given by the following formula (4):

ΔA=arcsin(X′ (θ)/(R+ΔR (θ))−arccos(Zp/R) (4).

The image deviation distance ΔP [mm] is given by the following formula (5):

ΔP=2πR{ΔA/(2π)} (5).

In this case, when the processing speed is given as Vp, the time equivalent to the image deviation (deviation time) ΔT [ms] is given by the following formula (6):

ΔT=ΔP/Vp (6).

Accordingly, in the present embodiment, the position at which the leading end of paper P abuts photoreceptor drum 3 can be corrected by correcting the timing for actuating registration roller 15 by deviation time ΔT in accordance with eccentric variation ΔR(θ) of the photoreceptor drum, it is hence possible to prevent image deviation of the toner image to be transferred to paper P.

According to the present embodiment thus configured as above, it is possible to correct the timing of driving registration roller 15 by determining the time equivalent ΔT to the image deviation based on the eccentric variation ΔR(θ) of the peripheral surface depending on the rotational phase (θ) of photoreceptor drum 3, detected by eccentric/phase sensor 62a. This correction enables the leading end of paper P to abut the transfer reference position to thereby achieve image transfer to the exact position without causing any image deviation.

Though an image misregistration at the border becomes conspicuous in borderless printing, it is possible for the present embodiment to prevent image misregistration at the border in a highly precise manner. It is also possible to prevent color misregistration between color developers in color printing, which is prone to be affected by the eccentricity of the photoreceptor drum.

Further, according to the present embodiment, since detection of the peripheral surface of photoreceptor drum 3 is adapted to be performed at end part 3c in a non-contact manner by eccentricity/phase sensor 62a using a reflection type optical sensor, it is possible to achieve exact detection without causing any influence on the toner image formed on photoreceptor drum 3 and without being affected by the toner image.

When continuous printout of sheets of an identical size is performed, it is possible to determine the transfer reference positions of the second sheet and thereafter, based on the size of the first paper (previous paper information) and the predetermined inter-paper distance without effecting detection of marking M for every sheet of paper.

Also, when continuous printout of sheets of an identical size is performed, it is possible to determine the transfer reference positions of the second sheet and thereafter, based on the timing of detection of the rear end of the first paper (previous paper information) and the predetermined inter-paper distance without effecting detection of marking M for every sheet of paper.

Further, when paper feed timing by registration roller 15 is adapted to be corrected not only based on the transfer reference position and the eccentric variation at that position but also based on the speed (process speed) of photoreceptor drum 3 which is changed over depending on the paper thickness and the like set up by operational condition setter 77 or by the output request from without, it is possible to deal with a change in the process speed when paper of a different thickness is used.

Further, when paper feed timing by registration roller 15 is adapted to be corrected based on the transfer reference position, the eccentric variation at that position and print number information, it is also possible to deal with a printing process of which the process speed needs to be lowered compared to the process speed for a single sheet in order to avoid occurrence of troubles such that it becomes difficult to keep up the necessary speed of toner supply and that the temperature of the developing hopper and the like exceeds the upper temperature limit when large-volume printing is performed at high speed.

It is also, of course possible to correct the paper feed timing by registration roller 15 based on the transfer reference position, the eccentric variation at that position, the process speed and printout number information.

Here, in the present embodiment, eccentricity/phase sensor 62a having both the function of an eccentricity detector and the function of a phase detector is used so as to detect the both the eccentric variation and rotational phase of the peripheral surface of photoreceptor drum 3. However, the present invention should not be limited to this configuration as long as an eccentricity detector for detecting the eccentric variation of the peripheral surface of photoreceptor drum 3 and a phase detector for detecting the rotational phase of photoreceptor drum 3 are included. That is, the eccentricity detector and phase detector may be configured separately from each other and positioned at appropriate positions.

The eccentricity detector may employ a magnetic sensor, which enables stable detection over a long period of time without being influenced by the toner and electrostatic latent image on the photoreceptor drum.

Though in the present invention, marking M is formed as an image, it may be formed with a mechanical recess or projection.

Also, as eccentricity/phase sensor 62a, various types can be employed in conformity with the configuration of marking M. For example, when a permanent magnet piece bonded to the inner surface of the photoreceptor drum is used instead of marking M, use of an eddy-current sensor in place of eccentricity/phase sensor 62a makes it possible to detect the variation and phase with a single eddy-current sensor.

Further, though in the present invention, marking M is provided at end part 3c on the peripheral surface of photoreceptor drum 3, placement of the marking is not limited to this but the marking may be laid out at any position as long as it permits detection of the rotational phase of photoreceptor drum 3. For example, marking M may be arranged on the circular flat side surface of photoreceptor drum 3 so that the rotational phase information and rotational phase reference information may be obtained by detecting the marking M with a separate phase detector.

Moreover, the way of acquisition of the photoreceptor drum correcting information is not limited to the detecting process with eccentricity/phase sensor 62a and calculating process of its detected result, but the photoreceptor drum correcting information may be acquired by reading it out from a recording medium. Since this configuration leaves out the need of performing the detecting process with eccentricity/phase sensor 62a and the calculating process of its detected result and enables simple and exact acquisition of the information, it is possible to simplify the operating function of numerical calculation in the controller. Now, a case in which a recording medium having photoreceptor drum correcting information (correcting table) recorded is provided for the photoreceptor drum will be described as the second embodiment.

### The Second Embodiment

FIGS. 1 to 3 and 7 are common to the second embodiment, so that description is omitted. Also, the components identical with those in the aforementioned first embodiment are allotted with the same reference numerals and their description is omitted.

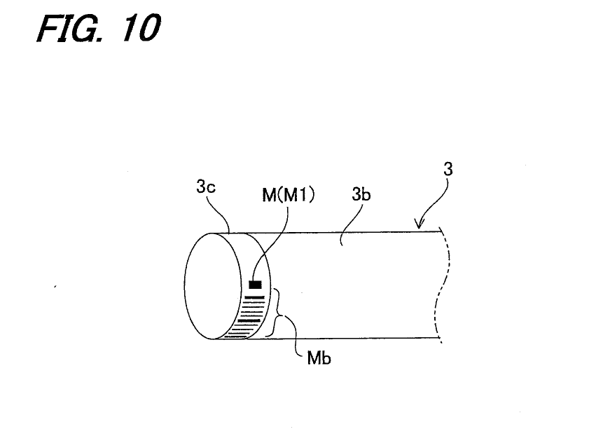

FIG. 10 is an illustrative view showing a detection area to be detected by a phase sensor, on the peripheral surface of the photoreceptor drum according to the second embodiment.

As shown in FIG. 10, an index marking M and barcode Mb are formed on the peripheral surface of photoreceptor drum 3 at its one end part 3c outside the area (toner image forming area), designated at 3b where a toner image is formed, with respect to the axial direction of photoreceptor drum 3. This area having marking M and barcode Mb forms a detection area.

Barcode Mb is recorded with information on photoreceptor drum 3, namely, photoreceptor drum correcting information including rotational phases of the photoreceptor drum relative marking M (rotational phase information), eccentric variations at the associated rotational phases (eccentricity information), paper colliding positions at which the paper collides with the photoreceptor drum, angular variations from the normal position when the paper collides with the eccentric position, the image deviation distances, time deviations of the registration roller actuating timing and the like.

Arranged near the peripheral surface of photoreceptor drum 3 is a phase sensor (phase detector, acquirer) 62d having a function of detecting the rotational phase of photoreceptor drum 3 and a barcode reading function 62d1 for reading barcodes, as shown in FIG. 3.

Phase sensor 62d uses a reflection type optical sensor, specifically, a reflection type photo interrupter and is arranged opposing photoreceptor drum 3 at a position on the upstream side of developing roller 2a with respect to the rotational direction of photoreceptor drum 3. In the present embodiment where developing roller 2a is arranged on the right side of photoreceptor drum 3 rotating in the direction of arrow A as shown in FIG. 3, phase sensor 62d is arranged over developing roller 2a. This layout makes it possible for phase sensor 62d to perform correct detection without it being dirtied by the falling toner that is supplied from developing roller 2a to photoreceptor drum 3.

Phase sensor 62d is arranged at one end with respect to the axial direction of photoreceptor drum 3, and detects marking M and barcode Mb and also detects the rotational phase of the transfer reference position relative to marking M (which will be referred to hereinbelow as “transfer reference position's rotational phase”).

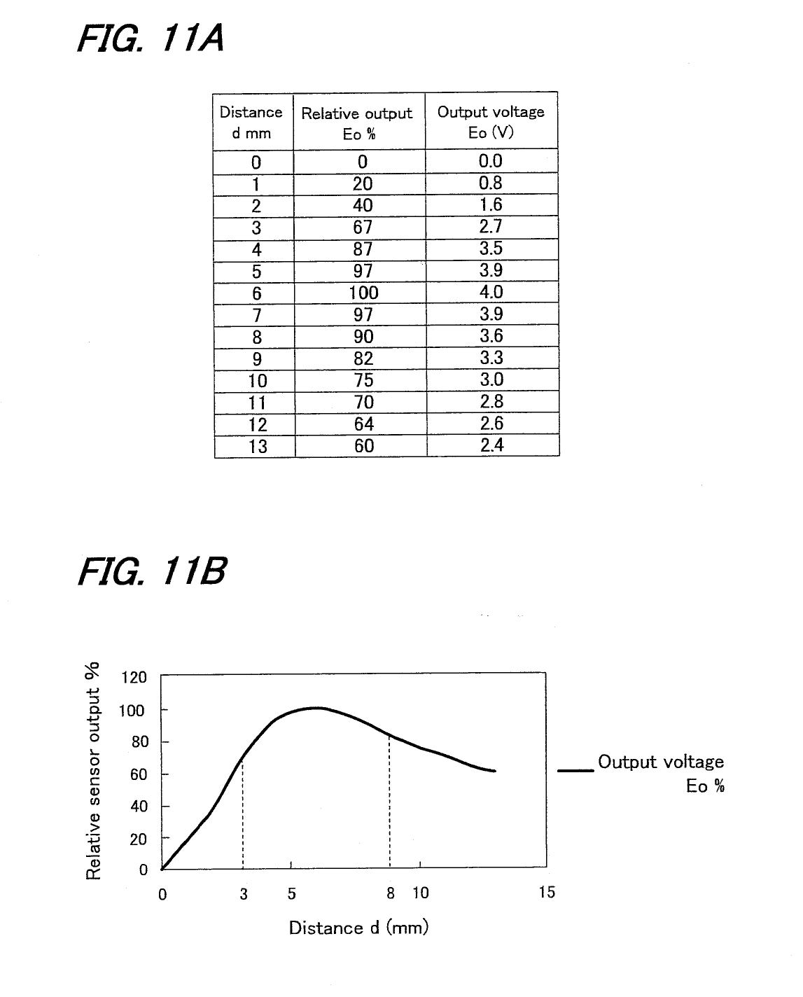

FIG. 11A is a data table showing the output voltage detected by the phase sensor, in relation with the detection distance from the sensor. FIG. 11B is a graph showing the detection sensitivity in the detection range of the phase sensor.

As shown in FIG. 11A, in the detecting process of an object under detection by phase sensor 62d, output voltage EoV from phase sensor 62d is measured by changing the detecting distance d in 1 mm increments, and then relative output Eo % to the maximum output voltage at each distance is calculated.

Phase sensor 62d is arranged so as to perform detection using the front side region in the detection range shown in FIG. 11B, specifically the region having a detecting distance ranging from 3 mm (or 4 mm) to 8 mm where the detection sensitivity rises. Use of this region for detection makes the detecting operation stable.

Here in the present embodiment, when the detecting distance d is 6 mm, the output voltage becomes maximum or takes a maximum output voltage Eo of 4.0V (relative output Eo % is set equal to 100%), where the detection sensitivity becomes most favorable.

The eccentricity information, rotational phase information and transfer reference position's rotational phase information, all recorded in barcode Mb are detected by phase sensor 62d and stored into part of image forming apparatus 1A.

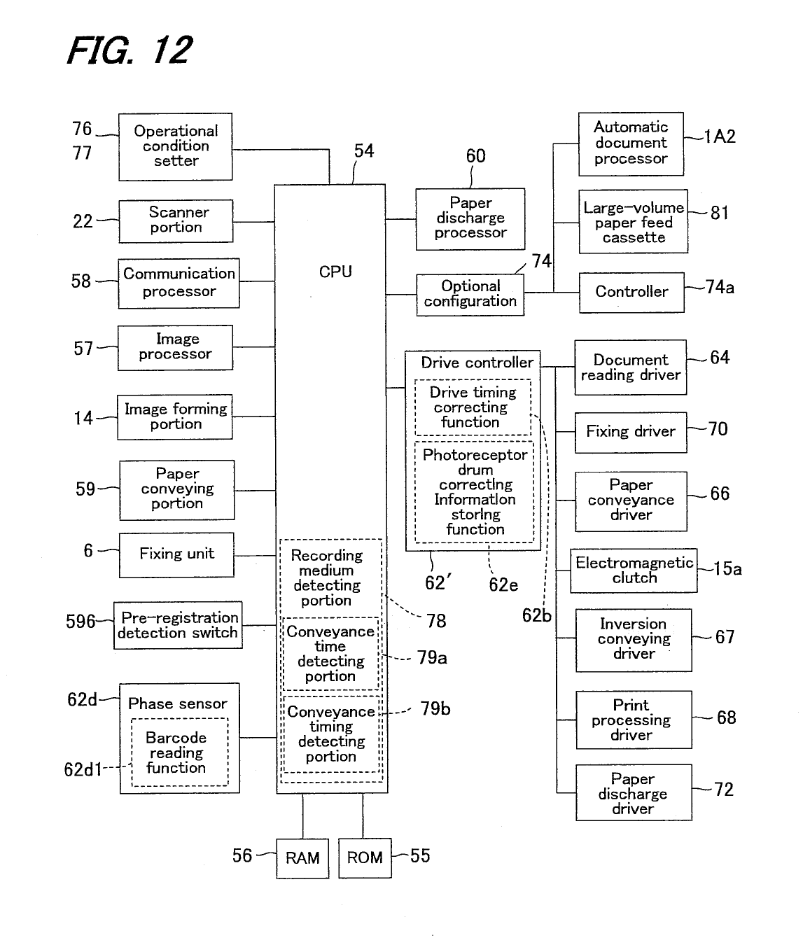

Registration roller 15 is adapted to be driven in an intermittent manner via an electromagnetic clutch 15a (see FIG. 12). This electromagnetic clutch 15a is operated and controlled by an after mentioned drive controller 62′ (see FIG. 12). Arranged on the upstream side of registration roller 15 with respect to the paper feed direction is a pre-registration detection switch 596 for detecting whether the paper reaches registration roller 15.

Next, the control system of image forming apparatus 1A according to the present embodiment will be described with reference to the drawings.

FIG. 12 is a block diagram showing an electric controller configuration of the image forming apparatus according to the present embodiment.

As shown in FIG. 12, image forming apparatus 1A according to the embodiment performs processes such as image reading, image processing, image forming and conveyance of paper P, etc., by a central processing unit (CPU) 54 which performs control in accordance with the program stored beforehand in ROM (read only memory) 55, in cooperation with temporal storage such as RAM (random access memory) 56 etc.

Here, it is also possible to use other storages such as a HDD (hard disk drive) etc., instead of ROM 55 and RAM 56.

In image forming apparatus 1A, the image information of an original (original image data) captured by scanner portion 22, or original image information transmitted from other terminal devices connected via an unillustrated communication network, is adapted to be input to an image processing portion 57 by way of a communication processor 58.

Image processor 57 shapes the original image information stored in the storage such as RAM 56 or the like into a printing image that is suitable for printing (image forming onto paper), in accordance with the aforementioned program.

The printing image information is input to image forming portion 14.

Image forming portion 14, paper conveying portion (performing various detections and controls of paper in paper feed path 7a, etc.) 59, fixing unit 6 and paper discharge processor (performing various detections and controls of paper in paper discharge roller 17) 60 are linked with drive controller 62′.

The paper conveyed by paper conveying portion 59 is led through the printing stage (the printing process of image information in image forming portion 14) and the fixing stage where the paper having been printed is fixed (in fixing unit 6) and then is discharged to paper discharge portion (paper output tray 9).

Here, paper conveying portion 59 receives detection signals from pre-registration detection switch 596, unillustrated fixing detection switch, paper discharge detection switch, etc.

The fixing detection switch is a switch for detecting whether the paper reaches fixing unit 6. The paper discharge detection switch is a switch for detecting whether the paper has been discharged.

Image forming apparatus 1A also includes an operational condition setter 77.

This operational condition setter 77 sets up the operational conditions for image forming and the conditions of conveyance etc., in image forming apparatus 1A, in accordance with the image forming request designated by the user through control switches 76 and/or the image forming conditions such as the type of recording media (paper) etc.

Further, in image forming apparatus 1A, in accordance with the set operational conditions (specifically, instructions from CPU 54 based on the program stored in ROM 55), drive controller 62′ controls the drive actuators for the document reader (scanner portion 22), paper conveying portion 59, image forming portion 14, fixing unit 6, paper discharge processor 60 etc., namely, a document reading driver 64, a paper conveyance driver 66, an inversion conveying driver 67, a print processing driver 68, a fixing driver 70 and a paper discharge driver 72, in synchronism.

Document reading driver 64 is the drive actuator for scanner portion 22.

Paper conveyance driver 66 means the drive motors for paper conveying portion 59, or paper pickup roller 8a and registration roller 15 along the aforementioned paper feed path 7a.

In the present embodiment, the drive motor for registration roller 15 is adapted to drive registration roller 15 by way of electromagnetic clutch 15a.

Inversion conveying driver 67 is the drive motor for inversion conveying roller 18.

Print processing driver 68 is the drive motor for photoreceptor drum 3.

Fixing driver 70 is the drive motor for heat roller 6a and pressing roller 6b in fixing unit 6.

Paper discharge driver 72 is the drive motor for paper discharge roller 17 and the like.

The drive motors for all these drivers may be provided as common or different drive motors with appropriate power transmission mechanisms.

Further, image forming apparatus 1A may be used with optional configurations 74 including post-processors (stapler, puncher, multi-bin paper output trays, shifter, etc.), automatic document reader (automatic document processor 1A2 etc.), large-volume paper feed cassette 81 and the like.

These optional configurations 74 incorporate individual controllers 74a separately in each optional configuration 74 from the controller of image forming apparatus 1A so that each processor can operate in synchronization by performing timing adjustment with the main apparatus 1A via the aforementioned communication processor 58.

A recording medium detecting portion 78 detects arrival of the leading end of the paper to fixing unit 6 or the output portion.

Specifically, recording medium detecting portion 78 includes a conveyance time detecting portion 79a and a conveyance timing detecting portion 79b.

Conveyance time detecting portion 79a measures the time of conveyance of the paper after the paper is delivered from registration roller 15.

Conveyance timing detecting portion 79b detects the timings at which the paper is conveyed in paper discharge path 7a, based on the distances from registration roller 15 to the objects to be controlled, i.e., fixing unit 6 and paper discharge drive roller 17 and based on the paper's speed of conveyance.

Recording medium detecting portion 78 in the present embodiment is adapted to detect the timings at which the paper arrives at (enter) fixing unit 6 and paper discharge roller 17, based on the conveyance timings of recording medium detected by conveyance timing detecting portion 79b.

In the present embodiment, drive controller 62′ further includes a drive timing correcting function 62b and a photoreceptor drum correcting information storage function 62e.

Drive timing correcting function 62b corrects the timing at which registration roller 15 is actuated by controlling the engaging and disengaging action of electromagnetic clutch 15a, based on the photoreceptor drum correcting information including rotational phase information as to the peripheral surface of photoreceptor drum 3 read from barcode Mb on photoreceptor drum 3, eccentricity information and the like read from barcode Mb on photoreceptor drum 3 and the rotational phase information of the transfer reference position.

Photoreceptor drum correcting information storage function 62e stores the photoreceptor drum correcting information including the eccentricity information and rotational phase information as to the peripheral surface of photoreceptor drum 3, read from barcode Mb on photoreceptor drum 3. That is, photoreceptor drum correcting information storage function 62e functions as a storage for storing data.

That is, the operational control of the electromagnetic clutch by drive controller 621 and paper feed by registration roller 15 are performed based on the photoreceptor drum correcting information including the eccentricity information and rotational phase information as to the peripheral surface of photoreceptor drum 3, read from barcode Mb on photoreceptor drum 3 and the rotational phase of the transfer reference position relative to marking M.

Next, correction of the actuating timing of registration roller 15 depending on the eccentric variation of photoreceptor drum 3 in image forming apparatus 1A will be described with reference to an example.

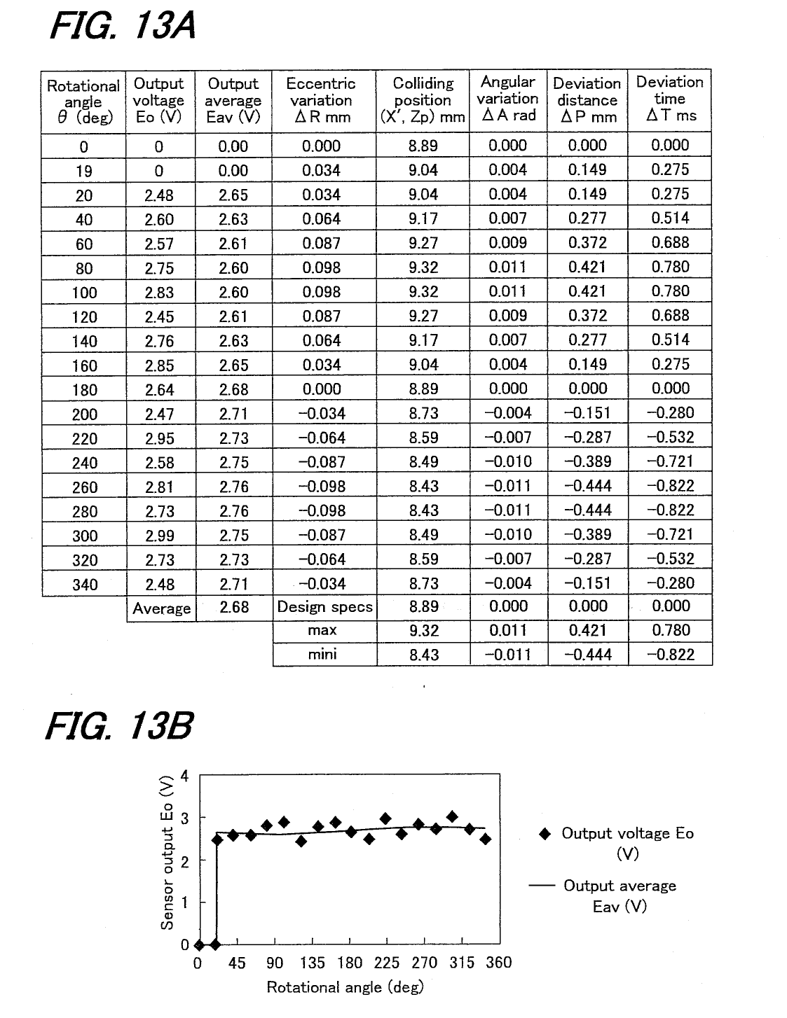

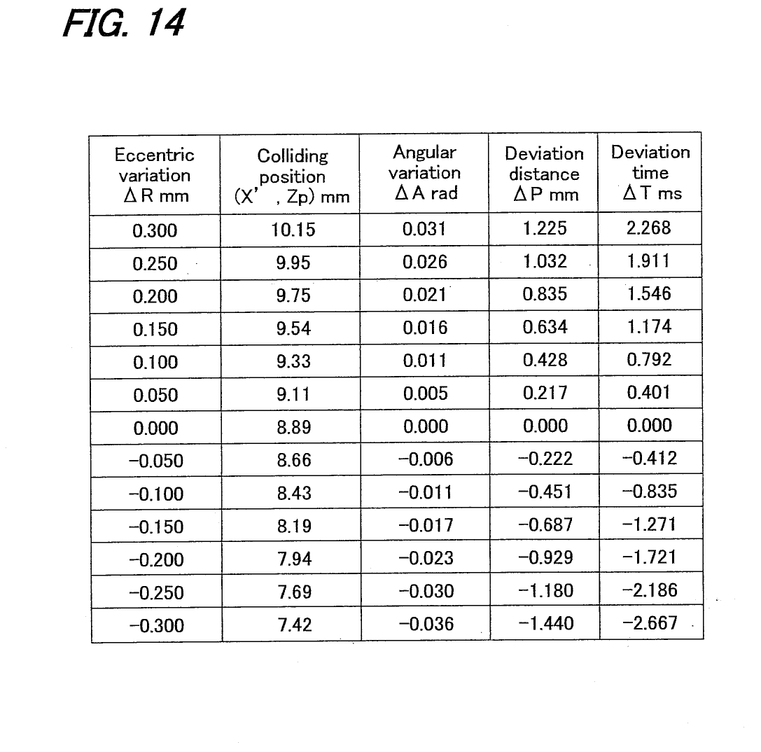

FIG. 13A is a data table showing photoreceptor drum correcting information recorded in barcode Mb in accordance with the present embodiment. FIG. 13B is a graph showing the relationship between the rotational angle and output voltage recorded in barcode Mb.

As shown in FIG. 10, photoreceptor drum 3 of the present embodiment is formed of a cylinder having an outside diameter of 80 mm with its aluminum base (surface-roughened) exposed 10 mm wide at its end part 3c with respect to the axial direction for rotational phase measurement. A black marking M1 of a 10 mm square is formed at end part 3c. Further, the eccentric variations at the rotational phases, which are obtained by dividing the whole circumference equi-angularly in every 20 degrees, assuming the lead of black marking M1 as the rotational phase reference, are recorded as the eccentricity information in barcode Mb.

Phase sensor 62d for reading black marking M1 and barcode Mb is arranged opposing photoreceptor drum 3 with a predetermined clearance apart therefrom. As phase sensor 62d a reflection type photo interrupter (a product of Sharp Corporation: GP2S28) is used and laid out with a clearance of 3.0 mm apart from the peripheral surface of photoreceptor drum 3.

First, the sensor output from phase sensor 62d at the time of detection is adjusted.

Phase sensor 62d acquires a sensor output E₃ when the sensor is set with a clearance of 3.0 mm from photoreceptor drum 3 when photoreceptor drum 3 is kept stationary.

Then, when image forming apparatus 1A is installed or when photoreceptor drum 3 is replaced, black marking M1 as the rotational phase reference of the photoreceptor drum 3 and barcode Mb are read by phase sensor 62d while photoreceptor drum 3 is rotated at the normal speed (process speed), and eccentric variations ΔR(θ) of the photoreceptor around the whole photoreceptor drum circumference are acquired at every 20 degrees of rotational angle, based on the rotational angle when black marking M1 is detected. The thus obtained data is stored as the eccentricity information into a recording medium (RAM, hard disk or the like).

The relationship between the rotational phase of photoreceptor drum 3 and the sensor output at the corresponding position is obtained from the photoreceptor drum correcting information recorded in barcode Mb and shown in FIG. 13A, and is represented by the graph shown in FIG. 13B. That is, the sensor output curve changes its curvature at a rotational phase of 180°, to the opposite direction as shown in FIG.13B. That is, photoreceptor drum 3 is understood to be eccentric.

From the photoreceptor drum correcting information recorded in barcode Mb and shown in the table of FIG. 13A, photoreceptor drum 3 is understood to be eccentric so that its maximum eccentric variation ΔR is 0.098 mm in the rotational phase range of 80° to 100° and −0.098 mm in the rotational phase range of 260° to 280°.

Here, the position at which paper P collides with the surface of a photoreceptor drum 3 having a normal shape is represented as paper colliding position (X, Zp), and the position at which paper P collides with the surface of an eccentric photoreceptor drum 3′ (the portion represented by the two-dot chain line in FIG. 3) is represented as paper colliding position (X′, Zp) [mm].

When the rotational angle is θ, the Z-axis position Zp of the paper colliding position (X′ (θ), Zp) at which the leading end of paper P collides with photoreceptor drum 3′ is set equal to 39.0 [mm] (downward) (Zp=39.0 [mm]). Therefore, the X-axis position X′ (θ) [mm] in the drawing can be given by the above formula (3).

Angular variation ΔA of paper colliding position (X′ (θ), Zp) is given by the above formula (4).

The image deviation distance ΔP is given by the above formula (5).

When the processing speed is given as Vp, the time corresponding to image deviation (deviation time) ΔT is given by the above formula (6).

Accordingly, in the present embodiment, the position at which the leading end of paper P abuts the transfer reference position can be corrected by correcting the timing for actuating registration roller 15 by deviation time ΔT in accordance with eccentric variation ΔR(θ) of the photoreceptor drum, it is hence possible to prevent image deviation of the toner image to be transferred to paper P.

According to the present embodiment thus configured as above, it is possible with phase sensor 62 to detect the rotational phase (θ) of the transfer reference position. The photoreceptor drum correcting information can be acquired from barcode Mb. Accordingly, it is possible to determine eccentric variation ΔR(θ) depending on rotational phase (θ) and the time corresponding to image deviation or deviation time ΔT, from the photoreceptor drum correcting information. It is therefore possible to easily correct the actuation timing of registration roller 15 in accordance with the eccentric variation of photoreceptor drum 3 so as to make the leading end of paper P abut the transfer reference position, whereby it is possible to transfer the image to the exact position without causing any misregistration.

As a result, it is possible to prevent, for example image misregistration of the image to the paper in borderless printing and color misregistration between color developers in color printing, which are prone to be affected by the eccentricity of the photoreceptor drum.

The photoreceptor drum correcting information does not necessarily include all the records of rotational phases, and sensor output voltage, average sensor output voltage, eccentric variation of the photoreceptor drum, paper colliding position, angular variation, deviation distance and deviation time at each rotational phase, but the information required for the process may be selectively recorded.

Further, it is not necessary to limit the invention to the configuration in which all pieces of photoreceptor drum correction information required for the process are recorded in bar code Mb as shown in FIG. 10. In other words, it is possible to calculate the necessary photoreceptor drum correcting information using the above formulae (2) to (6) based on the information read out from barcode Mb. That is, it is possible to provide a configuration by combining the first and second embodiments.

The recording medium for recording photoreceptor drum correcting information is not limited to barcodes. That is, any medium can be used as long as the image forming apparatus can read out information from it by means of an optical, magnetic, electric or electronic reader. For example, it is possible to use optical disks such as CDs, DVDs etc., magnetic disks such as hard disks etc., magneto-optical disks such as MOs etc., and semiconductor recording media such as IC chips, semiconductor memories etc.

Use of an optical disk, magnetic disk, magneto-optical disk and/or semiconductor medium instead of the barcode makes it possible to acquire photoreceptor drum correcting information in a simple and exact manner by just adding the separately constructed recording medium as part of the image forming apparatus without the necessity of performing any data reading operation with a detecting sensor.

The timing for reading the photoreceptor drum correcting information is not particularly limited. That is, the information may be read from the recording medium when the photoreceptor drum is assembled into the apparatus, when the apparatus is installed, when an image forming process is effected, when the apparatus is maintained after the photoreceptor drum has been replaced or at any other time.

Though the above description was made referring to a case where black marking M1 and barcode Mb are provided, the present invention should not be limited to this. When barcode Mb is also used as the reference for rotational phases, black marking M1 may be omitted.

Further, according to the present embodiment, detection of the peripheral surface of photoreceptor drum 3 is performed at end part 3c in a non-contact manner using phase sensor 62d of a reflection type optical sensor, so that it is possible to achieve exact detection without causing any influence on the toner image formed on photoreceptor drum 3 and without being affected by the toner image.

Though in the present embodiment, barcode Mb is provided directly on the photoreceptor drum, the present invention should not be limited to this. That is, the barcode may be provided for another entity that is separate from the photoreceptor drum, for example, the box that packages the photoreceptor drum.

Further, in a case where the input means of the photoreceptor drum correcting information is limited to the reading from the recording medium such as a barcode or the like, the photoreceptor drum correcting information may be directly input by the operator.

It goes without saying that the second embodiment also has the operational effect of the first embodiment.

Having described preferred embodiments of the present invention, it goes without saying that the present invention should not be limited to the above-described examples, and it is obvious that various changes and modifications will occur to those skilled in the art within the scope of the appended claims. Such variations are therefore understood to be within the technical scope of the present invention.

For example, in the above-described embodiment, the present invention is applied to an image forming apparatus including a monochrome developing unit, but the present invention can be also be applied to a color image forming apparatus including a plurality of developing units. Application of the present invention to a color image forming apparatus presents markedly effectiveness in preventing color misregistration between color developers.

What is claimed is:

1. An image forming apparatus that is controlled so as to transfer a toner image formed on the peripheral surface of a photoreceptor drum to a recording medium by electrophotography, comprising:
an image forming portion including the photoreceptor drum on which a toner image is formed based on the electrostatic latent image formed thereon;
a developing portion having a developing roller for supplying toner to the photoreceptor drum;
a recording medium conveyor for conveying a recording medium toward the photoreceptor drum;
a controller for controlling the drive of the recording medium conveyor; and
a transfer portion for transferring the toner image formed on the photoreceptor drum to the recording medium being conveyed, characterized in that
the recording medium conveyor conveys the recording medium in such a manner that the leading end of the recording medium collides with the photoreceptor drum;
the controller includes: an eccentricity detector for detecting the eccentric variation of the peripheral surface of the photoreceptor drum; and a phase detector for detecting the rotational phase of the photoreceptor drum; and
the controller corrects the timing of driving the recording medium conveyor based on the eccentric variation detected by the eccentricity detector and the rotational phase detected by the phase detector.

2. The image forming apparatus according to claim 1, wherein the recording medium conveyor is constructed so that drive force is transmitted thereto in an intermittent manner by way of an electromagnetic clutch.

3. The image forming apparatus according to claim 1, wherein the detected eccentric variations and rotational phases are stored in part of the image forming apparatus.

4. The image forming apparatus according to claim 1, wherein the eccentricity detector detects the peripheral surface of the photoreceptor drum at an end part thereof.

5. The image forming apparatus according to claim 1, wherein the eccentricity detector is an optical sensor.

6. The image forming apparatus according to claim 5, wherein the eccentricity detector is a reflection type sensor.

7. The image forming apparatus according to claim 5, wherein the eccentricity detector is arranged opposing the photoreceptor drum at a position on the upstream side of the developing roller with respect to the rotational direction of the photoreceptor drum.

8. The image forming apparatus according to claim 5, wherein the eccentricity detector performs detection using the front side region in the detection range of the eccentricity detector.

9. The image forming apparatus according to claim 5, wherein rotational phase reference information is provided in part of an area under detection on the photoreceptor drum to be detected by the eccentricity detector, and the eccentricity detector has a function of detecting the rotational phase of the photoreceptor drum.

10. The image forming apparatus according to claim 9, wherein the controller assumes the eccentric variation in the area under detection at the position where the rotational phase reference information is given, to be the value that is obtained by multiplying (−1) into the value of the eccentric variation in the area under detection at the position that is located 180° with respect to the rotational direction of the photoreceptor drum, apart from the position where the rotational phase reference information is disposed.

11. The image forming apparatus according to claim 1, wherein the controller causes the eccentricity detector to detect the eccentric variation at each phase over the whole circumferential surface of the photoreceptor drum a multiple number of times, and regards the average of the measurements as the eccentric variation of the photoreceptor drum's peripheral surface at that phase.

12. The image forming apparatus according to claim 1, wherein the phase detector detects the rotational phase of the position from which image data starts to be written in.

13. The image forming apparatus according to claim 1, wherein the controller corrects the timing based on the eccentric variation, the rotational phase and recording medium information.

14. The image forming apparatus according to claim 13, wherein the recording medium information is the recording medium information on the recording medium that has been conveyed previously.

15. The image forming apparatus according to claim 13, wherein the recording medium information includes the length information of the recording medium.

16. The image forming apparatus according to claim 13, wherein the controller includes a recording medium rear end detector, and the recording medium information is the timing at which the rear end of the recording medium is detected by the recording medium rear end detector.

17. The image forming apparatus according to claim 1, wherein the controller corrects the timing based on the eccentric variation, the rotational phase and process speed information.

18. The image forming apparatus according to claim 1, wherein the controller corrects the timing based on the eccentric variation, the rotational phase and print number information.

19. The image forming apparatus according to claim 1, wherein the eccentricity detector is a magnetic sensor.

20. An image forming apparatus that is controlled so as to transfer a toner image formed on the peripheral surface of a photoreceptor drum to a recording medium by electrophotography, comprising:
an image forming portion including the photoreceptor drum on which a toner image is formed based on the electro static latent image formed thereon;
a developing portion having a developing roller for supplying toner to the photoreceptor drum;
a recording medium conveyor for conveying a recording medium toward the photoreceptor drum;
a controller for controlling the drive of the recording medium conveyor; and
a transfer portion for transferring the toner image formed on the photoreceptor drum to the recording medium being conveyed, characterized in that
the recording medium conveyor conveys the recording medium in such a manner that the leading end of the recording medium collides with the photoreceptor drum;
the controller includes a phase detector for detecting the rotational phase of the photoreceptor drum; and
the controller corrects the timing of driving the recording medium conveyor based on the rotational phase detected by the phase detector and based on the acquired photoreceptor drum correcting information including eccentricity information on the peripheral surface of the photoreceptor drum and the rotational phase information of the photoreceptor drum.

21. The image forming apparatus according to claim 20, wherein the recording medium conveyor is constructed so that drive force is transmitted thereto in an intermittent manner by way of an electromagnetic clutch.

22. The image forming apparatus according to claim 20, wherein the photoreceptor drum correcting information is stored in part of the image forming apparatus.

23. The image forming apparatus according to claim 20, wherein the phase detector is an optical sensor.

24. The image forming apparatus according to claim 20, wherein an optical sensor is used as an acquirer for acquiring the photoreceptor drum correcting information.

25. The image forming apparatus according to claim 24, wherein the phase detector has a function of the acquirer.

26. The image forming apparatus according to claim 23, wherein the phase detector is a reflection type sensor.

27. The image forming apparatus according to claim 23, wherein the phase detector is arranged opposing the photoreceptor drum at a position on the upstream side of the developing roller with respect to the rotational direction of the photoreceptor drum.

28. The image forming apparatus according to claim 20, wherein the phase detector detects the rotational phase of the position from which image data starts to be written in.

29. The image forming apparatus according to claim 20, wherein the controller corrects the timing based on the rotational phase, the photoreceptor drum correcting information and recording medium information.

30. The image forming apparatus according to claim 29, wherein the recording medium information includes the length information of the recording medium.

31. The image forming apparatus according to claim 29, wherein the controller includes a recording medium rear end detector, and the recording medium information is the timing at which the rear end of the recording medium is detected by the recording medium rear end detector.

32. The image forming apparatus according to claim 20, wherein the controller corrects the timing based on the eccentric variation, the rotational phase and process speed information.

33. The image forming apparatus according to claim 20, wherein the controller corrects the timing based on the eccentric variation, the rotational phase and print number information.
